(19) United States
(12) Patent Application Publication
(10) Pub. No.: US 2026/0169580 A1
(43) Pub. Date: Jun. 18, 2026

(54) ELECTRONIC PEN

(71) Applicant: Wacom Co., Ltd., Saitama (JP)

(72) Inventors: Kohei TANAKA, Saitama (JP); Takenori KANEDA, Saitama (JP)

(73) Assignee: Wacom Co., Ltd., Saitama (JP)

(21) Appl. No.: 19/537,002

(22) Filed: Feb. 11, 2026

Related U.S. Application Data
(63) Continuation of application No. PCT/JP2024/025203, filed on Jul. 12, 2024.
(60) Provisional application No. 63/519,494, filed on Aug. 14, 2023.

(51) Int. Cl. G06F 3/038; G06F 3/0354

(52) U.S. Cl. CPC G06F 3/0383; G06F 3/03545

(57) ABSTRACT

Provided is an electronic pen including a casing capable of separating into a pen tip side and a rear end side that is an opposite side from the pen tip side in an axial direction, an electronic pen main body disposed on the pen tip side in the casing, and a power supply including a battery and disposed on the rear end side in the casing. A first terminal is provided on a rear end side in the axial direction of the electronic pen main body, and a second terminal is provided on a pen tip side in the axial direction of the power supply. The electronic pen main body and the power supply are provided so as to be arranged in the axial direction.

### BACKGROUND

### Technical Field

The present disclosure relates to an electronic pen having a function of performing signal interaction with a position detecting sensor, and particularly to an electronic pen including a power supply using a battery.

### Description of the Related Art

An active capacitive type electronic pen and an electromagnetic induction type electronic pen are well known electronic pens. The active capacitive type electronic pen includes a signal transmitting circuit for transmitting a signal for interacting with a position detecting sensor, and includes a power supply for supplying a power supply voltage to the signal transmitting circuit. In addition, in a case where the electromagnetic induction type electronic pen transmits pen pressure information, identification information, and the like as digital information to an electronic apparatus side including the position detecting sensor, the electromagnetic induction type electronic pen includes a circuit for generating the digital information, and includes a power supply for supplying a power supply voltage to the circuit.

A conventional electronic pen, whether the conventional electronic pen is the active capacitive type electronic pen or the electromagnetic induction type electronic pen, is formed by electrically coupling a circuit having a function of performing signal interaction with the position detecting sensor (functional part of an electronic pen main body) and a power supply including a battery to each other, and is configured to house these in a columnar housing space of a hollow portion within a casing of the electronic pen.

Recently, as illustrated in Domestic Re-publication of PCT International Publication for Patent Application No. 2020/148977) and Domestic Re-publication of PCT International Publication for Patent Application No. 2017/010336), for example, an electronic pen has also been proposed which is configured such that internal parts of the electronic pen are modularized or unitized, and the modularized parts or the unitized parts are housed within the columnar housing space of a hollow portion of a casing of the electronic pen. Also in this case, the functional part of the electronic pen main body having a function of performing signal interaction with the position detecting sensor and the power supply are electrically coupled to each other, and are formed as one modularized part or unitized part.

As the battery used in the power supply, there is a primary battery and a chargeable secondary battery. An electronic pen that allows the primary battery and the secondary battery to be used interchangeably is disclosed in WO2023/248507 A1, for example. In the electronic pen described in WO2023/248507 A1, a casing of the electronic pen is divided in two in an axial direction, that is, divided into a first casing portion on a pen tip side and a second casing portion on a rear end side, and the functional part of the electronic pen main body and the power supply each have a unitized configuration.

For the electronic pen in the case of WO2023/248507 A1, a power supply including a primary battery and a power supply including a secondary battery are prepared as the unitized power supply (power supply). Then, the rear end side in the axial direction of the unitized electronic pen main body is configured to be coupled to a fitting recess on the pen tip side in the axial direction of the power supply by being inserted and fitted into the fitting recess, and thereby also electrically coupled to the fitting recess. The power supply is configured to be changeable to either of the power supply including the primary battery and the power supply including the secondary battery.

In addition, recently, thin type electronic pens have often been desired. However, standardized batteries such as, for example, a size AA (AA; commonly known in the United States) battery and a size AAA (AAA; commonly known in the United States) battery have relatively large sizes. Even a thinnest size AAAA (AAAA; commonly known in the United States) battery has a diameter of 8.3 mm, and cannot be used for a thin type electronic pen. In addition, although there is a pin type lithium ion battery as a thin type battery, even a thinnest pin type lithium ion battery of a product number CG-320B manufactured by Panasonic Corporation has a diameter of 3.5 mm. This is also difficult to use in a thin type electronic pen.

On the other hand, there are batteries of various sizes as element type batteries. However, due to a difficulty in handling the element type batteries, an element type battery is often fixed to a circuit board within the electronic pen by soldering or the like. For example, WO2021/084824 A1 discloses an electronic pen in which a circuit board within the electronic pen has a special shape, and a lithium ion battery is fixed to the circuit board by a special method of soldering lead portions of a positive electrode and a negative electrode of the lithium ion battery to a side surface of the circuit board.

Now, the electronic pen including the power supply as described above can contribute to sustainable development goals (SDGS) by having a structure in which the batteries are interchangeable. In this case, the electronic pen desirably has a structure that allows replacement of a battery to be performed easily. Then, replacing the battery and repairing the electronic pen in a factory becomes easy, and a user can also easily replace the battery by himself/herself.

In addition, in a case where the battery is a lithium ion battery, when the electronic pen is disposed of while housing the battery, there is a risk of the battery catching fire in a pulverizing process in which the electronic pen is pulverized and sorted into metal, plastic, and other pulverized objects for recycling in a disposal plant.

Accordingly, when the electronic pen has a structure that allows the battery to be extracted easily, it can be expected that the user will extract the battery when disposing of the electronic pen. It is thus possible to avoid the risk of the battery catching fire as described above. In addition, also in the disposal plant, when the electronic pen has a structure that allows the battery to be extracted easily, work of removing the battery can be performed easily before the pulverization processing. It is thus possible to avoid the risk of the battery catching fire.

In the electronic pen disclosed in WO2023/248507 A1 described above, the electronic pen casing is divided in two, that is, into the first casing portion and the second casing portion, and is configured to include the electronic pen main body and the power supply. Thus, the battery can be replaced (extracted) by replacing (extracting) the power supply.

However, in the configuration of the electronic pen according to WO2023/248507 A1, the rear end side in the axial direction of the electronic pen main body is coupled to the fitting recess on the pen tip side in the axial direction of the power supply by being inserted and fitted into the fitting recess. It is therefore necessary to perform work of extracting the electronic pen main body and the power supply in the coupled state from the casing of the electronic pen and uncoupling the two units from each other after separating the first casing portion and the second casing portion from each other. Thus, the work of extracting (replacing) the power supply is relatively troublesome.

In the electronic pen according to WO2021/084824 A1, the battery is fixed to the circuit board by soldering or the like, as described above, in consideration of stability of the lithium ion battery. Removal of the battery is therefore troublesome.

### BRIEF SUMMARY

In order to solve the above problems, there is provided an electronic pen including a casing capable of separation into a pen tip side and a rear end side that is an opposite side from the pen tip side in an axial direction, an electronic pen main body disposed on the pen tip side within a hollow portion of the casing, and a power supply including a battery and disposed on the rear end side within the hollow portion of the casing. There is also a first terminal portion provided on a rear end side in the axial direction of the electronic pen main body and a second terminal portion being on a pen tip side in the axial direction of the power supply. Within the hollow portion of the casing, the first terminal portion of the electronic pen main body and the second terminal portion of the power supply are in contact with and electrically coupled to each other, and the electronic pen main body and the power supply are provided so as to be arranged in the axial direction without being physically coupled to each other by inserting and fitting an end portion in the axial direction of one of the electronic pen main body and the power supply into an end portion in the axial direction of the other. The power supply is extractable to an outside of the casing by separating the casing into the pen tip side and the rear end side.

In the electronic pen having the above-described configuration, the first terminal portion of the electronic pen main body and the second terminal portion of the power supply are in contact with and electrically coupled to each other. Moreover, the electronic pen main body and the power supply are provided so as to be arranged in the axial direction without being physically coupled to each other by inserting and fitting the end portion in the axial direction of one of the electronic pen main body and the power supply into the end portion in the axial direction of the other. Thus, the power supply is made extractable to the outside of the casing by separating the casing into the pen tip side and the rear end side. That is, the work of extracting (replacing) the power supply is very easy, and the removal of the power supply is not troublesome.

### BRIEF DESCRIPTION OF THE SEVERAL VIEWS OF THE DRAWINGS

FIGS. 1A and 1B are diagrams illustrating a configuration of a first embodiment of an electronic pen according to the present disclosure;

FIGS. 2A and 2B are diagrams illustrating principal parts of the configuration of the first embodiment of the electronic pen according to the present disclosure;

FIG. 3 is a diagram illustrating a configuration of a pen tip side constituent unit in the first embodiment of the electronic pen according to the present disclosure;

FIG. 4 is a diagram illustrating a configuration of a rear end side of an electronic pen main body in the first embodiment of the electronic pen according to the present disclosure;

FIGS. 5A, 5B, and 5C are diagrams illustrating a configuration of a power supply in the first embodiment of the electronic pen according to the present disclosure;

FIGS. 6A, 6B, 6C, 6D, and 6E are diagrams illustrating a configuration of a part of the power supply in the first embodiment of the electronic pen according to the present disclosure;

FIG. 7 is a diagram illustrating a state of electric connection between the electronic pen main body and the power supply in the first embodiment of the electronic pen according to the present disclosure;

FIG. 8 is a diagram illustrating the state of electric connection between the electronic pen main body and the power supply in the first embodiment of the electronic pen according to the present disclosure;

FIGS. 9A and 9B are exploded views of illustrating a configuration of a cap in the first embodiment of the electronic pen according to the present disclosure;

FIGS. 10A, 10B, and 10C are sectional views illustrating coupling and uncoupling between a casing main body and the cap in the first embodiment of the electronic pen according to the present disclosure;

FIG. 11 is a block diagram illustrating an example of an electronic circuit in the first embodiment of the electronic pen according to the present disclosure;

FIGS. 12A and 12B are diagrams illustrating a configuration of a second embodiment of the electronic pen according to the present disclosure;

FIG. 13 is a diagram illustrating a configuration of a third embodiment of the electronic pen according to the present disclosure;

FIG. 14 is a block diagram illustrating an example of an electronic circuit in the third embodiment of the electronic pen according to the present disclosure;

FIGS. 15A and 15B are diagrams illustrating a configuration of a fourth embodiment of the electronic pen according to the present disclosure;

FIGS. 16A and 16B are diagrams illustrating a configuration of a fifth embodiment of the electronic pen according to the present disclosure;

FIGS. 17A and 17B are diagrams illustrating a configuration of a sixth embodiment of the electronic pen according to the present disclosure;

FIGS. 18A and 18B are diagrams illustrating an electronic pen in another configuration example of the electric connection between the electronic pen main body and the power supply;

FIGS. 19A and 19B are sectional illustrating another configuration example of the cap in the first embodiment of the electronic pen according to the present disclosure;

FIG. 20 is a sectional view illustrating another configuration example of the cap in the first embodiment of the electronic pen according to the present disclosure; and

FIGS. 21A and 21B are sectional views illustrating another configuration example of the cap in the first embodiment of the electronic pen according to the present disclosure.

### DETAILED DESCRIPTION

Several embodiments of an electronic pen according to the present disclosure will hereinafter be described with reference to the drawings.

### First Embodiment

### Outline of Electronic Pen According to Embodiment

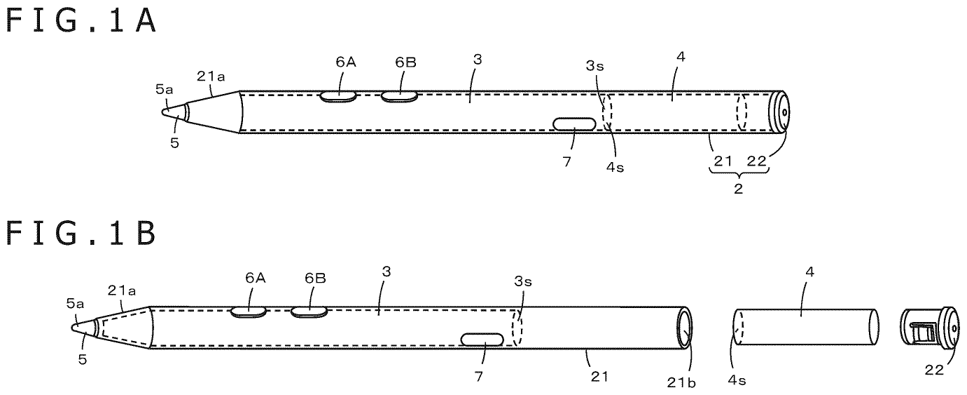

FIGS. 1A and 1B are diagrams illustrating an outline of a configuration of an electronic pen 1 according to a first embodiment of the present disclosure. FIG. 1A is a diagram illustrating a configuration of the whole of the electronic pen 1. FIG. 1B is an exploded view illustrating constituent parts of the electronic pen 1.

The electronic pen 1 according to the present first embodiment is formed by housing an electronic pen main body 3 and a power supply 4 within a hollow portion of an electronic pen casing 2. The electronic pen main body 3 performs signal interaction with a position detecting sensor, and performs position indication input on the position detecting sensor. The electronic pen main body 3 in the present embodiment has an active capacitive configuration. In addition, the power supply 4 is to supply a power supply voltage necessary for the electronic pen main body 3. The power supply 4 in the present example has a configuration including a rechargeable battery.

The electronic pen casing 2 in the present first embodiment is constituted by a casing main body 21 in a tubular shape and a cap 22. The casing main body 21 is formed of a conductive material, for example, resin mixed with metal or conductive powder. The cap 22 is formed of a nonconductive material, for example, resin.

The casing main body 21 has a taper-shaped portion 21a gradually tapered off on a pen tip side as one end side in an axial direction, and an opening (not illustrated in FIGS. 1A and 1B) in which a core body 5 is inserted is formed at a distal end of the taper-shaped portion 21a. As illustrated in FIGS. 1A and 1B, the core body 5 is fitted to the pen tip side of the electronic pen main body 3 in a state in which a distal end portion 5a of the core body 5 projects outward from the opening of the taper-shaped portion 21a of the casing main body 21.

In the present first embodiment, the electronic pen casing 2 is formed by fitting the cap 22 to the rear end side of the casing main body 21 so as to close an opening 21b (see FIG. 1B) on the rear end side as an opposite side from the pen tip side of the casing main body 21. In the present embodiment, the electronic pen casing 2 can be separated into the casing main body 21 on the pen tip side and the cap 22 on the rear end side in the axial direction by removing the cap 22 from the rear end side of the casing main body 21.

In the electronic pen 1 according to the present embodiment, the electronic pen main body 3 is configured to be modularized to be capable of being handled as one part, and the power supply 4 is configured to have a unit configuration to be capable of being handled as one part. In the present example, the unit of the power supply 4 is formed in a cylindrical shape.

The electronic pen main body 3 in the present example is housed within the electronic pen casing 2 in a state in which the pen tip side of the electronic pen main body 3 is butted against an inner wall within a hollow portion of the taper-shaped portion 21a on the pen tip side within the electronic pen casing 2 (within the casing main body 21 in the present example) and thus the electronic pen main body 3 is immovable to the pen tip side in the axial direction within the hollow portion of the electronic pen casing 2. Moreover, in the present embodiment, the power supply 4 is provided so as to be arranged in the axial direction on the rear end side of the electronic pen main body 3 within the electronic pen casing 2 (within the casing main body 21 in the present example).

In this case, the electronic pen main body 3 and the power supply 4 are simply provided so as to be arranged in the axial direction without having a physical coupling structure such that, for example, an end portion in the axial direction of one of the electronic pen main body 3 and the power supply 4 is provided with a fitting recess, and an end portion in the axial direction of the other is inserted and fitted to the fitting recess.

In the present embodiment, as illustrated in FIGS. 1A and 1B, the electronic pen main body 3 is of a configuration having an end surface 3s as a flat surface in a direction orthogonal to the axial direction on the rear end side of the electronic pen main body 3, and the power supply 4 is of a configuration having an end surface 4s as a flat surface in the direction orthogonal to the axial direction on the pen tip side of the power supply 4. Moreover, the end surface 3s on the rear end side of the electronic pen main body 3 and the end surface 4s on the pen tip side of the power supply 4 are provided with electric terminals.

Hence, due to this configuration, the electronic pen main body 3 and the power supply 4 within the electronic pen casing 2 (within the casing main body 21 in the present example) are housed in a state in which the end surface 3s and the end surface 4s are butted and abut against each other. Moreover, in the present embodiment, the terminals provided to the end surface 3s and the end surface 4s, respectively, are configured to come into electric contact with each other to be electrically coupled to each other in a state in which the end surface 3s and the end surface 4s abut against each other. Incidentally, the cap 22 is provided with an elastic member, and the power supply 4 is configured to be elastically biased from the rear end side to the pen tip side by the elastic member of the cap 22 within the electronic pen casing 2. Hence, the end surface 3s and the end surface 4s are elastically in pressure contact with each other and abut against each other, so that the strength of the electric coupling is enhanced.

Because the electronic pen main body 3 and the power supply 4 are not physically coupled to each other, when the cap 22 is removed from the rear end side of the casing main body 21, the power supply 4 can be ejected from the rear end side of the casing main body 21 to the outside, and can be thereby extracted easily, as illustrated in FIG. 1B.

Incidentally, in the electronic pen 1 according to the present embodiment, the electronic pen main body 3 includes side switches capable of on-off operation by an operator of the electronic pen 1, and includes a charging circuit that charges a battery of the power supply 4. As illustrated in FIGS. 1A and 1B, at positions of a peripheral side surface of the casing main body 21 which positions can be operated by a finger when the operator grips the electronic pen 1, operation buttons 6A and 6B for the operation of the side switches by the operator are provided in a state of being exposed to the outside.

In the present embodiment, the charging circuit is of a type that performs charging while receiving a charging voltage (charging current) from the outside of the electronic pen 1 through a charging terminal. A terminal formed by a universal serial bus (USB) connector is used as the charging terminal in the present example. In the present embodiment, as illustrated in FIGS. 1A and 1B, an opening 7 for the USB connector is provided at a position of the peripheral side surface of the casing main body 21 which position corresponds to the rear end side of the electronic pen main body 3. This opening 7 can be provided with a lid member that can be opened and closed.

### Example of Detailed Configuration of Electronic Pen 1

A further description will next be made of an example of a detailed configuration of the electronic pen 1 according to the present embodiment.

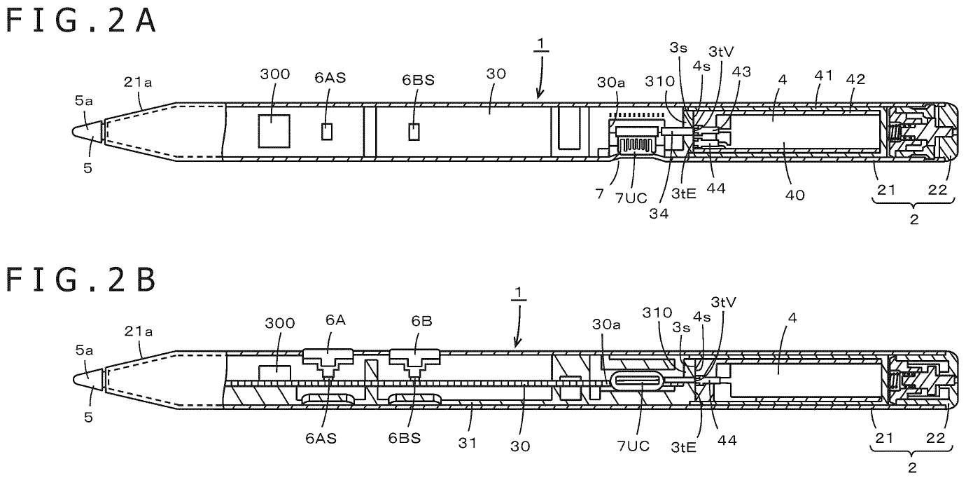

FIGS. 2A and 2B are longitudinal sectional views of parts except the pen tip side of the electronic pen 1 according to the present embodiment. FIG. 2A is a longitudinal sectional view when the electronic pen 1 is sectioned by a plane in a direction parallel with the board surface of a circuit board 30 included in the electronic pen main body 3, and FIG. 2B is a longitudinal sectional view when the electronic pen 1 is sectioned by a plane in a direction perpendicular to the board surface of the circuit board 30 included in the electronic pen main body 3. However, a sectional configuration of the power supply 4 is omitted except for a terminal portion thereof.

In the electronic pen main body 3, as illustrated in FIG. 2B, the circuit board 30 is provided in a state of being held by a holder 31 formed of an insulating material, or resin in the present example. As illustrated in FIG. 2B, the holder 31 has a boat-like shape extending from the pen tip side to the rear end side in the axial direction of the electronic pen main body 3, and includes a mounting portion for the circuit board 30 and a holding portion (not illustrated in FIGS. 2A and 2B) for a pen tip side constituent unit to be described later.

Moreover, as illustrated in FIGS. 2A and 2B, side switches 6AS and 6BS are arranged on the board surface of the circuit board 30 in the electronic pen main body 3 so as to be turned on and off by the operation buttons 6A and 6B, as illustrated in FIG. 2B. In addition, as illustrated in FIGS. 2A and 2B, a rectangular notch 30a is provided on the rear end side of the circuit board 30, and a USB connector 7UC is disposed at the position of the notch 30a. The notch 30a is formed as a notch corresponding to the shape and size of the USB connector 7UC. The opening 7 for the USB connector 7UC is provided so as to correspond to the position of the notch 30a.

Further provided on the board surface of the circuit board 30 are circuit elements (not illustrated except for an integrated circuit (IC) 300) for forming a circuit including a signal transmitting circuit and the IC 300 for performing signal interaction with the position detecting sensor, a circuit for generating the power supply voltage from a voltage from the power supply 4, the charging circuit for charging the battery of the power supply 4, and the like.

### Example of Pen Tip Side Constituent Unit of Electronic Pen Main Body 3

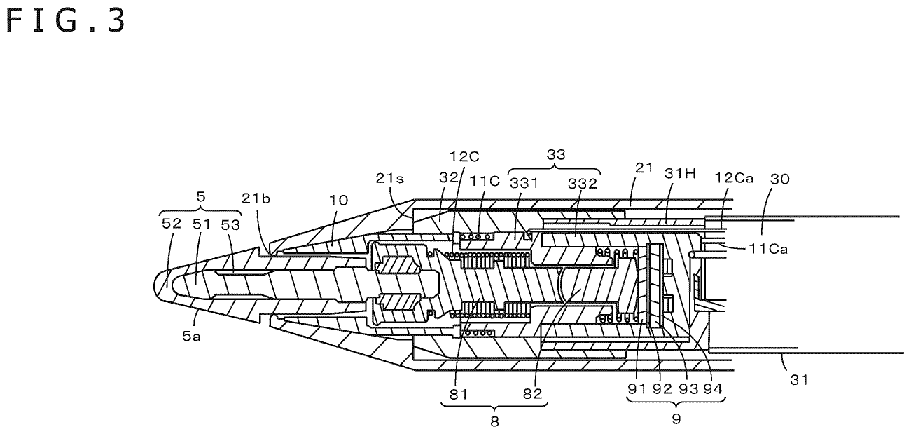

FIG. 3 illustrates an example of a configuration of the pen tip side constituent unit of the electronic pen main body 3. As illustrated in FIG. 3, the pen tip side constituent unit in the present example includes a pen pressure transmitter 8, a pen pressure detector 9, and a peripheral electrode 10. The core body 5 in the active capacitive electronic pen 1 according to the present embodiment is formed by a conductive member. The core body 5 is inserted from the opening on the pen tip side of the electronic pen casing 2 into the electronic pen casing 2 and fitted to the pen pressure transmitter 8 to form a part of the pen tip side constituent unit.

The peripheral electrode 10 is formed in a tubular shape by a conductive material, for example, a conductive metal, and is disposed so as to surround the core body 5 including a central electrode having conductivity, as will be described later. In the present example, the peripheral electrode 10 plays a role of an electrode that receives a signal from the position detecting sensor side. In the present example, the peripheral electrode 10 has a tapered shape tapered off toward the pen tip.

The holding portion for the pen tip side constituent unit as a part of the holder 31 has a configuration of a tubular portion 31H. A pen tip side cap 32 formed of a material that is an insulating material and has elasticity, for example, a nonconductive rubber is attached to the pen tip side of the tubular portion 31H of the holder 31. Then, the pen pressure transmitter 8 and the pen pressure detector 9 are provided within a hollow portion of the tubular portion 31H and the pen tip side cap 32. The peripheral electrode 10 is held by the pen tip side cap 32.

The pen pressure transmitter 8 and the pen pressure detector 9 are housed and held within a pen pressure detector holder 33 disposed within the hollow portion of the tubular portion 31H and the pen tip side cap 32. An electric connection terminal of the pen pressure detector 9 as well as a terminal electrically coupled to the peripheral electrode 10 and a terminal electrically coupled to a conductor part (central electrode) of the core body 5 is led out from the rear end side of the tubular portion 31H.

As illustrated in FIG. 3, the pen pressure detector holder 33 is formed by coupling a pipe-shaped holder 331 and a cup-shaped pen pressure detector holder 332 to each other. Then, within a communicating space within the peripheral electrode 10 and the pen pressure detector holder portion 33, the core body 5, the pen pressure transmitter 8, and the pen pressure detector 9 are provided so as to have a same central axis position and so as to be arranged serially in the axial direction.

Moreover, as illustrated in FIG. 3, the peripheral electrode 10 in the present example is coupled to a predetermined conductor pattern on the circuit board 30 through a coil spring 11C for the peripheral electrode formed by a conductive metal. An end portion 11Ca of the coil spring 11C is led out onto the circuit board 30.

As illustrated in FIG. 3, the core body 5 in the present example is formed by covering most of a central electrode 51 formed of a conductive material excluding a rear end side thereof with a protective member 52 formed of a nonconductive material. In the case of the present example, as illustrated in FIG. 3, the core body 5 has a structure provided with a space (air layer) 53 between the central electrode 51 and the protective member 52. Thus, a signal (electric field) from the central electrode 51 is radiated relatively efficiently, and an excellent signal that does not become broader than necessary can be sent out from the central electrode 51.

The pen pressure transmitter 8 in the present embodiment is formed by, for example, a hard resin as a nonconductive material, and is constituted by two separate members separated from each other, that is, a core body holding member 81 located on the pen tip side to hold the core body 5 and a pressing member 82 engaged with the pen pressure detector 9. The core body holding member 81 has a conductive elastic member 81c in a part thereof for holding the core body 5. Moreover, the core body 5 is coupled to the signal transmitting circuit on the circuit board 30 through a core body coil spring 12C provided to the periphery of the core body holding member 81 and formed of a conductive material, or a conductive metal in the present example. An end portion 12Ca of the core body coil spring 12C is extended onto the circuit board 30, as illustrated in FIG. 3.

In the present example, as illustrated in FIG. 3, the pen pressure detector 9 has a configuration of a well-known variable capacitance capacitor formed by facing a first electrode 91 toward one surface of a dielectric 93 with a ring-shaped spacer 92 interposed therebetween, and affixing a second electrode 94 to another surface of the dielectric 93. The first electrode 91 is formed of a conductive elastic material such as, for example, a conductive rubber.

### Example of Configuration of Principal Parts of Electronic Pen Main Body 3

The pen tip side constituent unit of the electronic pen main body 3 is configured as described above. The electronic pen main body 3 is housed into the casing main body 21 from the opening on the rear end side of the casing main body 21. As illustrated in FIG. 3, the electronic pen main body 3 is set in a state of not being further moved to the pen tip side in a state in which the external surface of a tapered portion of the peripheral electrode 10 abuts against the inner wall surface of the hollow portion of the taper-shaped portion 21a of the casing main body 21. In addition, in the present embodiment, as illustrated in FIG. 3, a stepped portion 21s having a surface orthogonal to the axial direction is formed on the inner wall surface of a rear end of the taper-shaped portion 21a of the casing main body 21. Then, as illustrated in FIG. 3, a distal end on the pen tip side of the pen tip side cap 32 of the electronic pen main body 3 abuts against the stepped portion 21s on the inner wall surface of the casing main body 21. This also sets the electronic pen main body 3 in a state of not being further moved to the pen tip side.

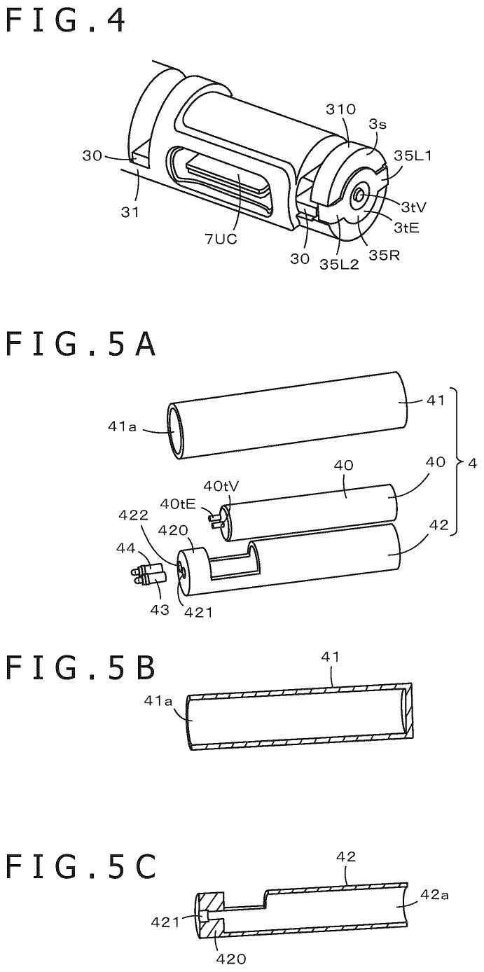

In the present embodiment, as illustrated in FIGS. 2A, 2B, and 4, the boat-like holder 31 of the electronic pen main body 3 includes a wall 310 having the end surface 3s in the direction orthogonal to the axial direction in an end portion on the rear end side of the boat-like holder 31. On the end surface 3s as an exposed surface on the rear end side of the wall 310, as illustrated in FIGS. 2A, 2B, and 4, a terminal 3tV coupled to a positive (+) side terminal of the circuit for generating the power supply voltage on the circuit board 30 and a terminal 3tE coupled to a grounding terminal of the circuit board are provided in a state of being exposed to the outside.

In the present embodiment, the end surface 3s of the wall 310 has a circular shape. The terminal 3tV is provided at a central position of the end surface 3s in the circular shape. In the present embodiment, as illustrated in FIGS. 2A and 2B, this terminal 3tV is constituted by an electrode pin 34 coupled to the positive (+) side terminal of the circuit for generating the power supply voltage on the circuit board 30 and fixed to the circuit board 30. That is, in the present embodiment, the electrode pin 34 penetrates the wall 310, and the end surface of a pin head portion of the electrode pin 34 is provided as the terminal 3tV so as to be exposed at the central position of the end surface 3s in the circular shape.

As illustrated in FIG. 4, the terminal 3tE is formed by a conductor 35 including a ring-shaped portion 35R having an inside diameter larger than the diameter of the pin head portion of the electrode pin 34. Moreover, on the circular-shaped end surface 3s of the wall 310, the ring-shaped portion 35R of the conductor 35 is disposed on the periphery of the terminal 3tV with the position of the terminal 3tV as a central position of the ring-shaped portion 35R. In addition, the conductor 35 in the present example includes extended portions 35L1 and 35L2 extended from positions of the ring-shaped portion 35R which positions are separated from each other by a predetermined angle, or an angular interval of 180 degrees in the present example. As will be described later, these extended portions 35L1 and 35L2 are to electrically couple the conductor 35 to the grounding terminal of the circuit board 30 and to attach and lock the conductor 35 to the wall 310.

### Example of Configuration of Power Supply 4

FIG. 5A illustrates an exploded configuration view of the power supply 4. In the present embodiment, as illustrated in FIG. 5A, the power supply 4 is constituted by a battery 40, an outer case 41, an inner case 42, and two electrode pins 43 and 44. The battery 40 in the present embodiment has a configuration including a chargeable secondary battery. The electrode pins 43 and 44 in the present example are constituted by pogo pins that can be elastically extended or contracted in the axial direction. The electrode pin 43 is for a positive electrode. The electrode pin 44 is for a negative electrode. Incidentally, FIG. 5B is a longitudinal sectional view of the outer case 41, and FIG. 5C is a longitudinal sectional view of the inner case 42.

The battery 40 in the present example has a cylindrical shape, and internally has one to a plurality of secondary battery cells or lithium ion battery cells in the present example. The battery 40 has a positive electrode terminal 40tV and a negative electrode terminal 40tE on an end surface on one end side in the axial direction of the battery 40. The positive electrode terminal 40tV and the negative electrode terminal 40tE have configurations of lead portions formed by lead wires or the like coupled to the two electrode pins 43 and 44.

The battery 40 can be of a thin configuration by having a configuration including one to a plurality of lithium ion battery cells. The power supply 4 is therefore thinned as a whole. Thus, in the electronic pen 1 according to the present embodiment, the electronic pen casing 2 can be formed in a thin shape.

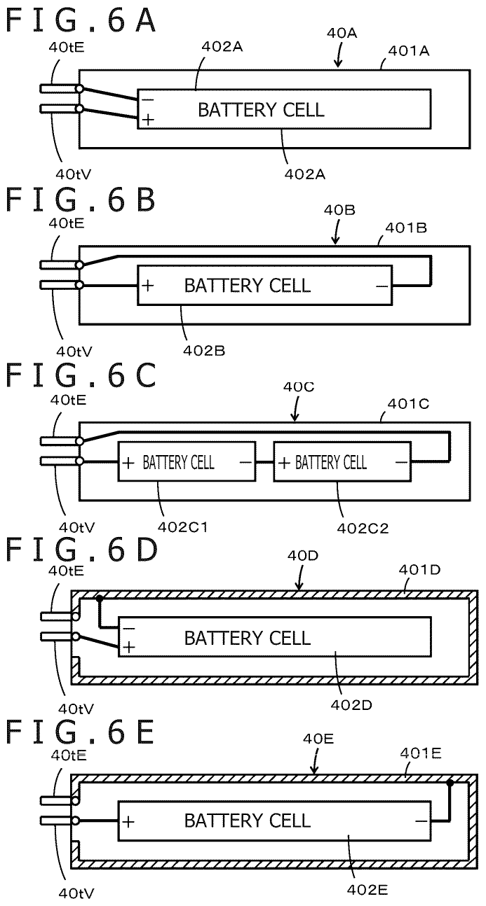

FIGS. 6A to 6E illustrate several configurations of the battery 40. A battery 40A in FIG. 6A is formed by housing one lithium ion battery cell 402A within a nonconductive case 401A formed of, for example, resin or the like. Then, in the present example, the lithium ion battery cell 402A is provided with a positive electrode and a negative electrode on one side in a longitudinal direction. The positive electrode of the lithium ion battery cell 402A is coupled to the positive electrode terminal 40tV. The negative electrode of the lithium ion battery cell 402A is coupled to the negative electrode terminal 40tE.

A battery 40B in an example of FIG. 6B is also formed by housing one lithium ion battery cell 402B within a nonconductive case 401B formed of, for example, resin or the like. Then, in the present example, the lithium ion battery cell 402B is provided with a positive electrode on one side in the longitudinal direction and a negative electrode on the other side in the longitudinal direction. The positive electrode of the lithium ion battery cell 402B is coupled to the positive electrode terminal 40tV. The negative electrode of the lithium ion battery cell 402B is coupled to the negative electrode terminal 40tE.

A battery 40C in an example of FIG. 6C is formed by housing a series connection of two lithium ion battery cells 402C1 and 402C2 within a nonconductive case 401C formed of, for example, resin or the like. Then, in the present example, a positive electrode of the lithium ion battery cell 402C1 is coupled to the positive electrode terminal 40tV, and a negative electrode of the lithium ion battery cell 402C2 is coupled to the negative electrode terminal 40tE.

A battery 40D in an example of FIG. 6D is formed by housing one lithium ion battery cell 402D within a conductive case 401D formed of, for example, a conductive metal or the like. In the present example, the conductive case 401D is coupled to the negative electrode terminal 40tE. Then, in the present example, the lithium ion battery cell 402D is provided with a positive electrode and a negative electrode on one side in the longitudinal direction. The positive electrode of the lithium ion battery cell 402D is coupled to the positive electrode terminal 40tV. The negative electrode of the lithium ion battery cell 402D is coupled to the conductive case 401D coupled to the negative electrode terminal 40tE.

A battery 40E in an example of FIG. 6E is formed by housing one lithium ion battery cell 402E within a conductive case 401E formed of, for example, a conductive metal or the like. The conductive case 401E is coupled to the negative electrode terminal 40tE. Then, in the present example, the lithium ion battery cell 402E is provided with a positive electrode on one side in the longitudinal direction and a negative electrode on the other side in the longitudinal direction. The positive electrode of the lithium ion battery cell 402E is coupled to the positive electrode terminal 40tV. The negative electrode of the lithium ion battery cell 402E is coupled to the case 401E coupled to the negative electrode terminal 40tE.

Any of the configurations of the battery 40A to 40E illustrated in FIGS. 6A to 6E may be adopted as the battery 40 of the power supply 4 in FIGS. 5A to 5C.

The inner case 42 is a cylindrical-shaped inner case that houses the battery 40. As illustrated in FIG. 5A and FIG. 5C, the inner case 42 has an opening 42a on a rear end side thereof, and a pen tip side thereof is closed by a disk-shaped wall 420 to which the two electrode pins 43 and 44 are attached. An end surface (exposed surface in the direction orthogonal to the axial direction) of the disk-shaped wall 420 in the present embodiment constitutes the above-described end surface 4s of the power supply 4.

The wall 420 is provided with through holes 421 and 422 that penetrate in the axial direction. The through hole 421 is formed at a central position of the end surface (exposed surface in the direction orthogonal to the axial direction) of the disk-shaped wall 420. The through hole 422 is formed at a position corresponding to a position in which the ring-shaped portion 35R of the conductor 35 formed on the above-described end surface 3s of the electronic pen main body 3 is present. That is, a distance of the ring-shaped portion 35R of the conductor 35 formed on the end surface 3s of the electronic pen main body 3 from the central position of the end surface 3s and a distance of the through hole 422 provided to the end surface 4s of the wall 420 from the central position of the end surface 4s are configured to be substantially equal to each other.

Then, the electrode pin 43 for the positive electrode penetrates the through hole 421, and is fitted to the wall 420 in a state in which a distal end portion of the electrode pin 43 slightly protrudes from the end surface 4s. In addition, the electrode pin 44 for the negative electrode penetrates the through hole 422, and is fitted to the wall 420 in a state in which a distal end portion of the electrode pin 44 slightly protrudes from the end surface 4s.

The outer case 41 is a cylindrical-shaped outer case that houses the inner case 42 housing the battery 40. As illustrated in FIG. 5A and FIG. 5B, the outer case 41 has an opening 41a on a pen tip side thereof, and a rear end side thereof is closed.

The battery 40 is inserted and housed from the opening 42a on the rear end side of the inner case 42 into the inner case 42 from a side on which the terminals 40tV and 40tE are formed. Then, the lead portion constituting the positive electrode terminal 40tV of the battery 40 housed within the inner case 42 and the rear end side of the electrode pin 43 are electrically coupled to each other by, for example, soldering or the like. In addition, the lead portion constituting the negative electrode terminal 40tE of the battery 40 and the rear end side of the electrode pin 44 are electrically coupled to each other by, for example, soldering or the like.

The inner case 42 in which the battery 40 has been housed as described above is inserted and housed from the opening 41a on the pen tip side of the outer case 41 into the outer case 41 from the rear end side of the inner case 42. In this case, the inner case 42 in which the battery 40 is housed is fastened to the outer case 41 by bonding or the like. In a state in which the inner case 42 is thus housed within the outer case 41, the end surface 4s of the wall 420 of the inner case 42 from which end surface the electrode pins 43 and 44 having a configuration of pogo pins protrude is exposed from the opening 41a of the outer case 41.

Description of Part in which Electronic Pen Main Body 3 and Power Supply 4 are Electrically Coupled to Each Other

In the electronic pen 1 according to the present embodiment, the power supply 4 is provided so as to be arranged on the rear end side of the electronic pen main body 3 within a hollow portion of the casing main body 21. In this case, in the present embodiment, the circular end surface 3s on the rear end side of the electronic pen main body 3 and the circular end surface 4s on the pen tip side of the power supply 4 are configured to be arranged such that the central positions of circular shapes thereof substantially coincide with each other.

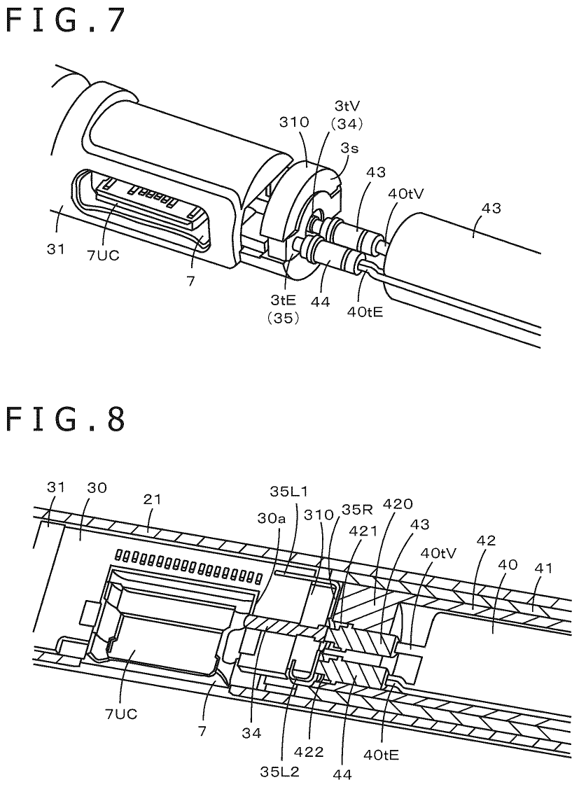

Thus, as illustrated in FIG. 7, the electrode pin 34 constituting the terminal 3tV located at the central position of the end surface 3s on the rear end side of the electronic pen main body 3 and the electrode pin 43 of the positive electrode coupled with the positive electrode terminal 40tV of the battery 40 located at the central position of the pen tip side end surface 4s of the power supply 4 abut against each other and are thereby electrically coupled to each other. In addition, the ring-shaped portion 35R of the conductor 35 constituting the terminal 3tE on the end surface 3s on the rear end side of the electronic pen main body 3 and the electrode pin 44 of the negative electrode coupled with the negative electrode terminal 40tE of the battery 40 of the power supply 4 abut against each other and are thereby electrically coupled to each other. In this case, because the electrode pin 44 of the power supply 4 is configured to abut against and come into contact with the ring-shaped portion 35R of the conductor 35 of the electronic pen main body 3, the power supply 4 reliably abuts against the ring-shaped portion 35R of the conductor 35 irrespective of a rotational direction position at which the electrode pin 44 is located. That is, in electrically coupling the electronic pen main body 3 and the power supply 4 to each other, an alignment in a rotational direction about the axial direction is rendered unnecessary.

Incidentally, FIG. 7 is a diagram illustrating abutting relations between the terminals 3tV and 3tE on the end surface 3s of the rear end side of the electronic pen main body 3 and the terminals (electrode pins 43 and 44) on the end surface 4s of the power supply 4. In FIG. 7, the outer case 41 and the inner case 42 of the power supply 4 are omitted for convenience.

In addition, FIG. 8 is a sectional view of a part in which the end surface 3s of the electronic pen main body 3 and the end surface 4s of the power supply 4 abut against each other within the casing main body 21 of the electronic pen 1 (sectional view sectioned by a plane in a direction parallel with the board surface of the circuit board 30). As illustrated in FIG. 8, the electrode pin 34 to which the terminal 3tV of the electronic pen main body 3 is coupled to is attached in a state of being fastened on the circuit board 30, and abuts against and is electrically coupled to the electrode pin 43 of the power supply 4.

In addition, the conductor 35 to which the terminal 3tE of the electronic pen main body 3 is coupled has the ring-shaped portion 35R attached to the end surface (end surface 3s) of the wall 310 of a rear end of the holder 31, has one extended portion 35L1 extended to the circuit board 30 and coupled to a grounding conductor, and has the other extended portion 35L2 bent to sandwich the wall 310. The conductor 35 is configured to be thereby locked to the wall 310. Moreover, as illustrated in FIG. 8, the electrode pin 44 of the power supply 4 abuts against and is electrically coupled to the ring-shaped portion 35R of the conductor 35 of the electronic pen main body 3.

### Example of Configuration of Cap 22

As described above, the electronic pen main body 3 and the power supply 4 are provided so as to be arranged in the axial direction within the hollow portion of the electronic pen casing 2 such that the end surface 3s and the end surface 4s abut against each other. The terminals 3tV and 3tE on the end surface 3s and the terminals (electrode pins 43 and 44) on the end surface 4s of the power supply 4 are electrically coupled to each other. In this case, in the present embodiment, the power supply 4 is configured to be elastically displaced to the electronic pen main body 3 side by the elastic member of the cap 22, so that the electric connection between the electronic pen main body 3 and the power supply 4 is established securely.

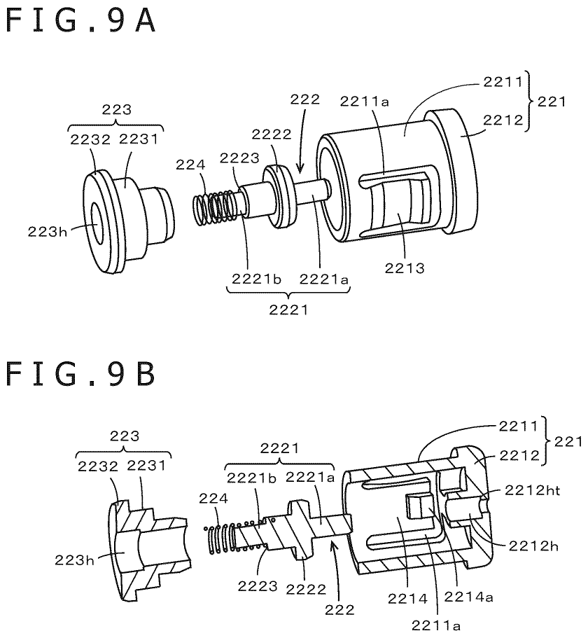

An example of a configuration of the cap 22 including the elastic member will next be described. FIG. 9A is an exploded perspective view of the cap 22 in the present embodiment, and FIG. 9B is a longitudinal sectional view of the cap 22. As illustrated in FIGS. 9A and 9B, the cap 22 in the present embodiment includes a cap main body 221, a locking control 222, a cap bottom 223, and a coil spring 224 constituting an example of the elastic member.

The cap main body 221 has a configuration in which one opening side of a tubular portion 2211 is closed by a cap head 2212. The outside diameter of the tubular portion 2211 is a diameter slightly smaller than the inside diameter of the casing main body 21. Moreover, the outside diameter of the cap head 2212 is a diameter substantially equal to the outside diameter of the casing main body 21. The cap head 2212 has a shape radially protruding in a flange form with respect to the tubular portion 2211.

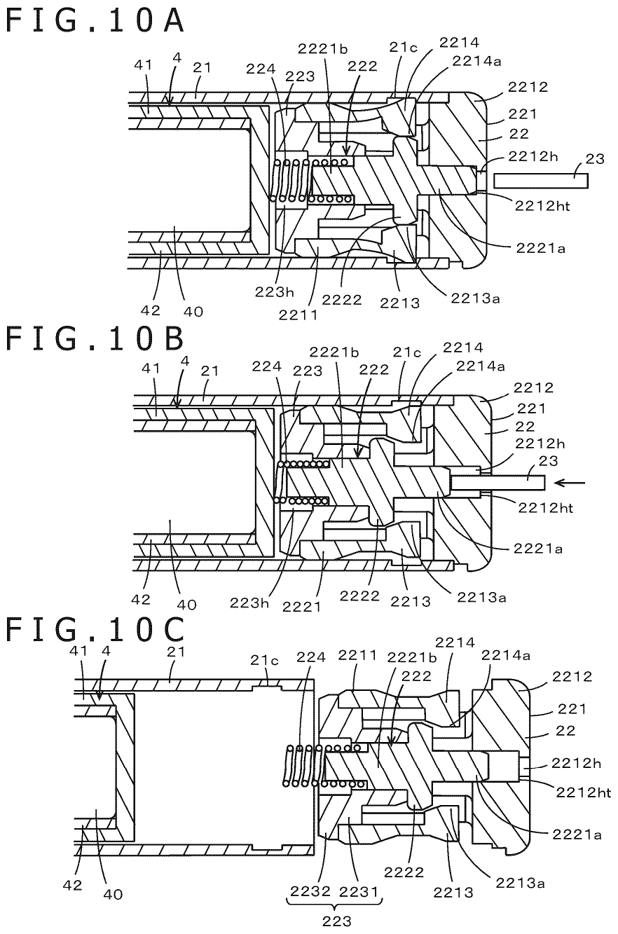

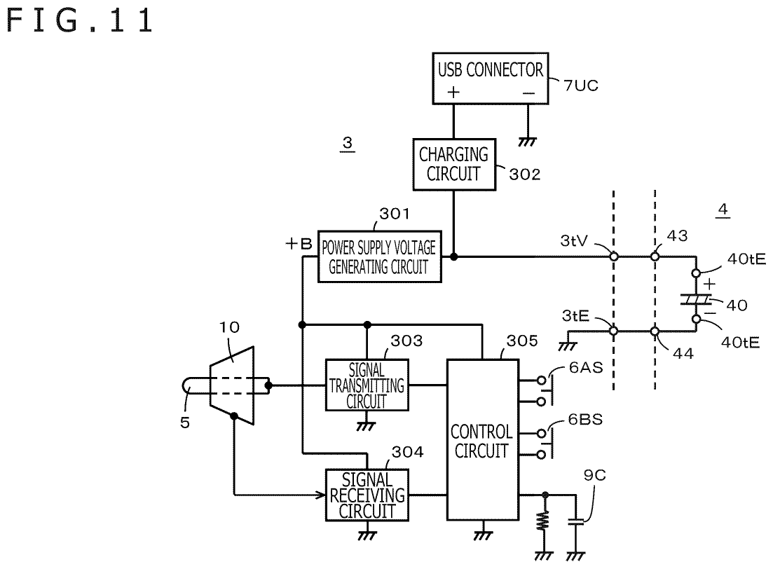

A through hole 2212h in the axial direction into which through hole to insert a rod-shaped jig 23 (see FIGS. 10A to 10C to be described later) used when removing the cap 22 from the casing main body 21 is formed at a central position of an end surface in a direction orthogonal to the axial direction of the cap head 2212. The diameter of the through hole 2212h is not uniform. The diameter of the through hole 2212h on the tubular portion 2211 side is selected to be larger than that on a side into which the jig 23 is inserted. Thus, the through hole 2212h includes a large-diameter portion and a small-diameter portion, and a step portion 2212ht is formed at a boundary therebetween.

In addition, as illustrated in FIGS. 9A and 9B, elastic pieces 2213 and 2214 capable of elastic displacement in the direction orthogonal to the axial direction are formed in the peripheral side surface of the tubular portion 2211 of the cap main body 221. As illustrated in FIGS. 9A and 9B, the elastic pieces 2213 and 2214 are formed by forming hook-shaped notch through grooves 2211a at positions displaced from each other by an angular interval of 180 degrees and opposed to each other in the peripheral side surface of the tubular portion 2211. Moreover, with the axial direction as a longitudinal direction of the elastic pieces 2213 and 2214, sides of the elastic pieces 2213 and 2214 which sides form free ends due to the presence of the notch through grooves 2211a in the longitudinal direction are elastically displaceable in the direction orthogonal to the axial direction.

Moreover, inner wall sides of the elastic pieces 2213 and 2214 of the tubular portion 2211 are provided with projecting portions 2213a and 2214a that project radially inward from the inner wall surfaces. The projecting portions 2213a and 2214a are provided to the sides that form free ends due to the presence of the notch through grooves 2211a in the longitudinal direction of the elastic pieces 2213 and 2214. Incidentally, for the convenience of illustration, of FIGS. 9A and 9B, FIG. 9B illustrates only the projecting portion 2214a provided to the inner wall surface of the elastic piece 2214, and does not illustrate the projecting portion 2213a provided to the inner wall surface of the elastic piece 2213 illustrated in FIG. 9A.

The locking control 222 is for controlling elastic displacement states of the elastic pieces 2213 and 2214 of the tubular unit 221. The locking control 222 is provided in a state of being movable in the axial direction within an internal hollow space of the tubular unit 221. As illustrated in FIGS. 9A and 9B, the locking control 222 has a configuration including a flange-shaped jut 2222 on an intermediate portion in the axial direction of a rod-shaped portion 2221.

The diameter of a part 2221a of the rod-shaped portion 2221 which part is more to the cap head 2212 side than the jut 2222 is a diameter smaller than that of the large-diameter portion of the through hole 2212h but larger than that of the small-diameter portion thereof. A structure is therefore obtained in which the part 2221a of the rod-shaped portion 2221 on the cap head 2212 side is inserted into the through hole 2212h but is not inserted into the small-diameter portion because the step portion 2212ht acts as a stopper.

In addition, a part 2221b of the rod-shaped portion 2221 which part is on an opposite side from the part 2221a is fitted with the coil spring 224. In the present example, a step portion 2223 against which one end side in the axial direction of the coil spring 224 abuts is formed on the part 2221b of the rod-shaped portion 2221, and the coil spring 224 is fitted so as not to fall off the locking control 222.

The length in a jutting direction of the jut 2222, that is, the magnitude of the outside diameter of the jut 2222 is such that the jut 2222 can engage with the projecting portions 2213a and 2214a on the inner wall surfaces of the elastic pieces 2213 and 2214 and elastically displace the elastic pieces 2213 and 2214 outward.

The cap bottom 223 is attached to an opening on the pen tip side of the cap 22. The cap bottom 223 includes an inserter 2231 that is inserted into the tubular unit 221 and a bottom surface plate 2232 having a flange portion that abuts against a ring-shaped opening end surface of the tubular unit 221. Moreover, the cap bottom 223 has a through hole 223h that penetrates in the axial direction at a central position of a circular surface of the bottom surface plate 2232. This through hole 223h has a diameter of a magnitude such that the part 2221b side on the cap bottom side of the rod-shaped portion 2221 of the locking control 222 can be inserted into the through hole 223h while a state in which the part 2221b is fitted with the coil spring 224 is maintained.

Then, the cap bottom 223 is fitted so as to cover an opening on the pen tip side of the tubular portion 2211 of the cap main body 221 in a state in which the locking control 222 is housed within the cap main body 221, and the cap bottom 223 is fastened to the cap main body 221 by, for example, bonding the flange of the bottom surface plate 2232 of the cap bottom 223 to the ring-shaped end surface of the tubular unit 221 of the cap main body 221. At this time, a part of the part 2221a of the rod-shaped portion 2221 of the locking control 222 which part is on the cap head 2212 side is inserted into the through hole 2212h within the cap main body 221, and the part 2221b of the rod-shaped portion 2221 which part is on the cap bottom 223 side is inserted in the through hole 223h of the cap bottom 223 (see FIG. 10C to be described later).

Attachment and detachment of the cap 22 configured as described above to and from the casing main body 21 will be described with reference to FIGS. 10A to 10C. FIG. 10A is a diagram illustrating a state in which the cap 22 is fitted and locked to the casing main body 21. FIG. 10B is a diagram illustrating a state in which the rod-shaped jig 23 is depressing the locking control 222 against an elastic force of the coil spring 224 in order to remove the cap 22 from the state in which the cap 22 is fitted and locked to the casing main body 21 in FIG. 10A. FIG. 10C is a diagram illustrating a state in which the cap 22 is detached from the casing main body 21 due to the depression of the locking control 222 by the rod-shaped jig 23.

Moreover, the state in which the cap 22 is fitted and locked to the casing main body 21, which state is illustrated in FIG. 10A, can be produced by pushing the cap 22 into the casing main body 21 in the state in which the cap 22 is detached from the casing main body 21, which state is illustrated in FIG. 10C.

In this case, in the present embodiment, as illustrated in FIGS. 10A, 10B, and 10C, a ring-shaped recess 21c for constituting a step portion that engages with the free end sides of the elastic pieces 2213 and 2214 of the cap main body 221 is formed in the inner wall surface on the rear end side of the casing main body 21. A formation position of the ring-shaped recess 21c is a position such that the free end sides of the elastic pieces 2213 and 2214 of the tubular portion 2211 of the cap main body 221 engage with the ring-shaped recess 21c when a flange-shaped protruding part of the cap head 2212 of the cap 22 abuts against the rear end side end surface of the casing main body 21.

In addition, in the present embodiment, in the cap 22, the jut 2222 of the locking control 222 and the projecting portions 2213a and 2214a of the inner walls of the elastic pieces 2213 and 2214 have shapes obtained by obliquely cutting engaging parts of both the jut 2222 and the projecting portions 2213a and 2214a, as illustrated in FIGS. 10A, 10B, and 10C, and are thus configured such that elastic displacement of the elastic pieces 2213 and 2214 by the jut 2222 of the locking control 222 is performed smoothly.

As illustrated in FIG. 10C, at a time of non-fitting, in the cap 22, the locking control 222 remains within the tubular unit 221 due to the presence of the jut 2222 of the locking control 222, the part 2221a on the cap head 2212 side of the rod-shaped portion 2221 of the locking control 222 is slightly inserted in the large-diameter part of the through hole 223h of the cap head 2212, and the part 2221b on the cap bottom 223 side of the rod-shaped portion 2221 of the locking control 222 is inserted within the through hole 223h of the cap bottom 223. Moreover, in this case, the coil spring 224 attached to the part 2221b on the cap bottom 223 side of the rod-shaped portion 2221 of the locking control 222 projects more outward than the bottom surface plate 2232 of the cap bottom 223. In addition, due to elastic forces of the elastic pieces 2213 and 2214, the jut 2222 of the locking control 222 is not engaged with the elastic pieces 2213 and 2214.

From this state, when the tubular unit 221 of the cap 22 is inserted from the opening on the rear end side of the casing main body 21, and the cap 22 is pushed into the rear end side of the casing main body 21, as illustrated in FIG. 10A, the coil spring 224 abuts against the rear end side of the outer case 41 of the power supply 4 within the casing main body 21, and produces a pressing elastic force of elastically displacing the power supply 4 to the electronic pen main body 3 side. However, as described above, the pen tip side of the electronic pen main body 3 abuts against the inner wall on the pen tip side of the casing main body 21, so that the electronic pen main body 3 and the power supply 4 are inhibited from movement to the pen tip side in the axial direction within the hollow portion of the casing main body 21.

Therefore, a reaction force of the pressing elastic force of elastically displacing the power supply 4 to the electronic pen main body 3 side occurs in the cap 22. Due to the reaction force, the locking control 222 is elastically displaced to the cap head 2212 side of the cap 22. This elastic displacement engages the jut 2222 of the locking control 222 with the projecting portions 2213a and 2214a of the inner walls of the elastic pieces 2213 and 2214, and generates a force that displaces the free end sides of the elastic pieces 2213 and 2214 in the direction orthogonal to the axial direction, that is, to the inner wall surface side of the casing main body 21.

When the cap 22 is pushed into the casing main body 21 in this state until the flange portion of the cap head 2212 abuts against the ring-shaped end surface on the rear end side of the casing main body 21, as illustrated in FIG. 10A, the free end sides of the elastic pieces 2213 and 2214 are in a position of facing the ring-shaped recess 21c of the inner wall surface of the casing main body 21.

Then, due to the elastic force of the coil spring 224, the jut 2222 of the locking control 222 engaging with the projecting portions 2213a and 2214a of the inner walls of the elastic pieces 2213 and 2214 moves to the cap head 2212 side along the tapered portions of the projecting portions 2213a and 2214a, displaces the free end sides of the elastic pieces 2213 and 2214 in the direction orthogonal to the axial direction, that is, in a direction of moving to the inner wall surface side of the casing main body 21, and protrudes the free end sides of the elastic pieces 2213 and 2214 from the side circumferential surface of the tubular portion 2211.

As a result, as illustrated in FIG. 10A, distal ends of the free end sides of the elastic pieces 2213 and 2214 engage with the ring-shaped recess 21c of the inner wall of the casing main body 21. The elastic force of the coil spring 224 firmly maintains the engagement state, and produces a state in which the distal ends of the free end sides of the elastic pieces 2213 and 2214 do not disengage as they are.

Moreover, in a state in which the cap 22 is fitted and locked to the casing main body 21, the coil spring 224 always elastically presses and displaces the power supply 4 to the electronic pen main body 3 side. Hence, the end surface 3s on the rear end side of the electronic pen main body 3 and the end surface 4s on the pen tip side of the power supply 4 are in pressure contact with each other, and the terminals provided to the end surface 3s and the end surface 4s are electrically securely coupled to each other.

The cap 22 fitted as described above can be easily removed from the casing main body 21 by using the rod-shaped jig 23. Specifically, as illustrated in FIG. 10B, the rod-shaped jig 23 is inserted into the through hole 2212h of the cap head 2212 of the cap 22 to depress the locking control 222 to the power supply 4 side against the elastic force of the coil spring 224.

Then, when the rod-shaped jig 23 depresses the locking control 222 to the power supply 4 side, and as illustrated in FIG. 10B, the engagement of the jut 2222 with the projecting portions 2213a and 2214a of the inner walls of the elastic pieces 2213 and 2214 is released, the free end sides of the elastic pieces 2213 and 2214 are elastically restored, and the engagement of the distal ends of the free end sides of the elastic pieces 2213 and 2214 with the ring-shaped recess 21c of the inner wall surface of the casing main body 21 is released.

Then, the cap 22 is able to move freely in the axial direction within the hollow portion of the casing main body 21. Therefore, due to the elastic force of the coil spring 224 applied to the locking control 222 of the cap 22, the cap main body 221 moves so as to spring out from the opening on the rear end side of the casing main body 21. Hence, the cap 22 can be easily removed from the rear end side of the casing main body 21, and the electronic pen casing 2 can be easily separated into the casing main body 21 and the cap 22.

Moreover, when the electronic pen casing 2 is thus separated into the casing main body 21 and the cap 22, the power supply 4 can be easily extracted from the opening on the rear end side of the casing main body 21 because the electronic pen main body 3 and the power supply 4 merely abut against each other such that the end surface 3s and the end surface 4s are in pressure contact with each other due to the elastic force of the coil spring 224 as the elastic member of the cap 22. That is, by removing the cap 22 from the rear end side of the casing main body 21, it is possible to extract the power supply 4 easily, and replace the power supply 4 easily.

### Configuration Example of Electric Circuit of Electronic Pen 1

As illustrated in FIG. 11, the electrode pin 43 coupled with the positive electrode terminal 40tV of the battery 40 of the power supply 4 is coupled to the terminal 3tV of the electronic pen main body 3, and the electrode pin 44 coupled with the negative electrode terminal 40tE of the battery 40 of the power supply 4 is coupled to the terminal 3tE coupled to the grounding conductor on the circuit board 30 of the electronic pen main body 3.

Moreover, in the electronic pen main body 3, the terminal 3tV is coupled to an input terminal of a power supply voltage generating circuit 301, and is coupled to an output terminal of a charging circuit 302. An input terminal of the charging circuit 302 is coupled to the USB connector 7UC. The USB connector 7UC is also coupled to the grounding conductor.

The charging circuit 302 supplies and charges the battery 40 of the power supply 4 with a charging current input through the USB connector 7UC via the terminal 3tV and the electrode pin 43 (pogo pin).

The power supply voltage generating circuit 301 receives a voltage from the power supply 4 through the electrode pin 43 and the terminal 3tV, and generates a power supply voltage +B. The generated power supply voltage +B is supplied to a signal transmitting circuit 303, a signal receiving circuit 304, and a control circuit 305. The control circuit 305 in the present example is coupled with a variable capacitance capacitor 9C constituted by the pen pressure detector 9. The control circuit 305 detects a pen pressure value from the capacitance of the variable capacitance capacitor 9C.

The signal transmitting circuit 303 includes an oscillating circuit having a predetermined frequency. The signal transmitting circuit 303 generates a signal under control of the control circuit 305, and transmits the signal to the position detecting sensor by capacitive coupling through the central electrode 51 of the core body 5. The signal transmitted from the signal transmitting circuit 303 includes a position detection signal and a pen pressure value information signal. The position detection signal is transmitted as a burst signal of a predetermined frequency. As for the pen pressure value information, in the present example, the pen pressure value is converted into a binary digital signal, and the binary digital signal is transmitted as an amplitude shift keying (ASK) modulated signal or an on-off keying (OOK) modulated signal, for example.

In the present example, the peripheral electrode 10 receives a signal from the position detecting sensor by capacitive coupling, and supplies the signal to the control circuit 305. The control circuit 305 controls timing of output of the signal from the signal transmitting circuit 303 in timing based on the signal received from the position detecting sensor.

As described above, in the electronic pen 1 in which the electronic pen main body 3 and the power supply 4 are housed so as to be arranged in the axial direction within the electronic pen casing 2, the electronic pen main body 3 receives a voltage from the battery 40 of the power supply 4 and generates the power supply voltage, and performs signal interaction with the position detecting sensor. It is thereby possible, on the position detecting sensor side, to detect a position indicated by the electronic pen 1, and detect the pen pressure value applied to the distal end of the core body 5.

### Second Embodiment

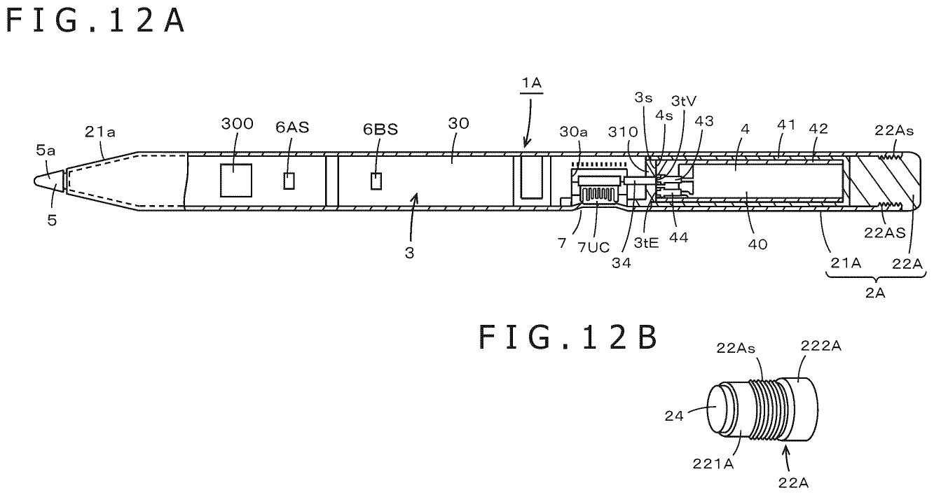

An electronic pen 1A according to a second embodiment is different from the electronic pen 1 according to the first embodiment only in terms of the configuration of the casing. The electronic pen main body 3 and the power supply 4 of the electronic pen 1A are configured in an exactly similar manner to those of the electronic pen 1 according to the first embodiment. FIG. 12A is a diagram illustrating an example of a configuration of the electronic pen 1A according to the second embodiment. This FIG. 12A corresponds to FIG. 2A illustrating an example of configuration of the electronic pen 1 according to the foregoing first embodiment. Incidentally, in the electronic pen 1A according to the second embodiment illustrated in FIGS. 12A and 12B, similar parts to those of the electronic pen 1 according to the foregoing first embodiment are identified by the same reference signs, and a detailed description thereof will be omitted.

Also in the electronic pen 1A according to the present second embodiment, an electronic pen casing 2A is constituted by a casing main body 21A and a cap 22A. FIG. 12B is a perspective view illustrating an example of the cap 22A. As illustrated in FIG. 12B, the cap 22A in the electronic pen 1A according to the present second embodiment is configured as a cap obtained by integrally forming a cap head 222A on one side in the axial direction of a cylindrical portion 221A.

The diameter of the cylindrical portion 221A of the cap 22A is set to be slightly smaller than the inside diameter of the casing main body 21A. Moreover, a threaded portion 22As is formed on the side circumferential surface of the cylindrical portion 221A. Further, an elastic member 24 formed of an elastic material, or an elastic rubber in the present example, is attached to an end surface of the cylindrical portion 221A which end surface is on an opposite side from the cap head 222A side.

The cap head 222A has a shape radially protruding in a flange form from the side circumferential surface of the cylindrical portion 221A. The outside diameter of the cap head 222A is a diameter substantially equal to the outside diameter of the casing main body 21A.

In the electronic pen 1A according to the present second embodiment, the electronic pen casing 2A is formed by inserting the cylindrical portion 221A of the cap 22A into a rear end of a hollow portion of the casing main body 21A, and screwing in (screwing) the cylindrical portion 221A to the casing main body 21A by the threaded portion 22As. As illustrated in FIG. 12A, a threaded portion 21As screwed onto the threaded portion 22As of the cap 22A is formed on the inner wall surface on the rear end side of the hollow portion of the casing main body 21A.

Moreover, in the electronic pen 1A according to the present second embodiment, as in the electronic pen 1 according to the first embodiment, the electronic pen main body 3 and the power supply 4 are housed so as to be arranged in the axial direction within the hollow portion of the casing main body 21A, and thereafter the cap 22A is screwed into and fitted to the rear end side of the casing main body 21A. In the present second embodiment, in a state in which the cap 22A is thus fitted to the rear end side of the casing main body 21, the elastic member 24 attached to the cap 22A presses and biases the power supply 4 to the electronic pen main body 3 side within the hollow portion of the casing main body 21A. Therefore, as in the foregoing first embodiment, the end surface 3s on the rear end side of the electronic pen main body 3 and the end surface 4s on the pen tip side of the power supply 4 are in pressure contact with each other, and the terminals provided to the end surface 3s and the end surface 4s are electrically securely coupled to each other.

Then, the electronic pen casing 2A is separated into the casing main body 21A and the cap 22A by unscrewing the cap 22A from the casing main body 21A. Hence, as in the electronic pen 1 according to the first embodiment, the power supply 4 can be easily extracted from the opening on the rear end side of the casing main body 21A. That is, by removing the cap 22A from the rear end side of the casing main body 21A, it is possible to extract the power supply 4 easily, and replace the power supply 4 easily.

It is to be noted that the elastic member 24 is not limited to elastic rubber, but may have a configuration of a leaf spring member or a coil spring. Moreover, instead of being attached to the cap 22A, the elastic member 24 may be configured to be interposed as a separate independent member between the cap 22A and the power supply 4. In addition, the cap 22A may have a configuration including a tubular portion in place of the cylindrical portion 221A. In that case, the elastic member 24 may have a configuration of an elastic rubber, a coil spring, a leaf spring, or the like provided to the inside of the tubular portion, or may have a configuration such that, for example, an elastic rubber is attached to a ring-shaped end surface of the tubular portion.

In addition, the electronic pen 1A according to the foregoing second embodiment has a configuration that couples and locks the casing main body 21A and the cap 22A to each other by screwing the two units to each other. However, the configuration that couples and locks the casing main body 21A and the cap 22A to each other is not limited to such a configuration. For example, a configuration may be adopted in which a ring-shaped protrusion or recess is provided to an inner circumferential side surface on the rear end side of the casing main body 21A, a ring-shaped recess or protrusion to be fitted to the ring-shaped protrusion or recess on the inner circumferential side surface on the rear end side of the casing main body 21A is formed on an outer circumferential side surface of the cylindrical portion 221A of the cap 22A, the ring-shaped recess or protrusion on the outer circumferential side surface of the cylindrical portion 221A of the cap 22A is fitted to the ring-shaped protrusion or recess on the inner circumferential side surface on the rear end side of the casing main body 21A by pushing the cap 22A into the casing main body 21A, and thereby the two units are coupled and locked to each other.

### Third Embodiment

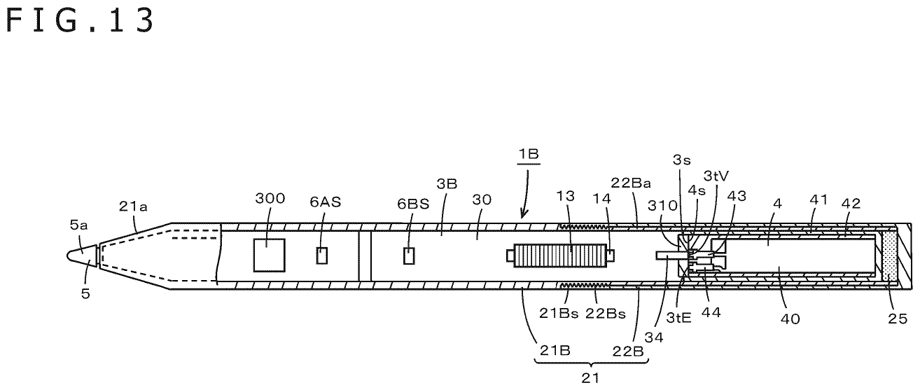

An electronic pen 1B according to a third embodiment is different from the electronic pen 1 according to the first embodiment in terms of the configuration of the electronic pen casing and a manner of charging the power supply 4, and is therefore different from the electronic pen 1 according to the first embodiment in terms of the configuration of corresponding parts of the electronic pen main body. FIG. 13 is a diagram illustrating an example of a configuration of the electronic pen 1B according to the third embodiment. This FIG. 13 corresponds to FIG. 2A illustrating an example of configuration of the electronic pen 1 according to the foregoing first embodiment. Incidentally, in the electronic pen 1B according to the third embodiment illustrated in FIG. 13, similar parts to those of the electronic pen 1 according to the foregoing first embodiment are identified by the same reference signs, and a detailed description thereof will be omitted.

An electronic pen main body 3B of the electronic pen 1B according to the present third embodiment does not include the USB connector 7UC for charging. Instead, a coil 13 for generating a charging current as an electromagnetically induced current is provided on the circuit board 30. In the present example, the coil 13 is wound around a magnetic core, or a ferrite core 14 in the present example. The other configuration of the electronic pen main body 3B of the electronic pen 1B according to the present third embodiment is a configuration similar to that of the electronic pen main body 3 of the electronic pen 1 according to the first embodiment, and includes the terminals 3tV and 3tE on the end surface 3s on the rear end side.

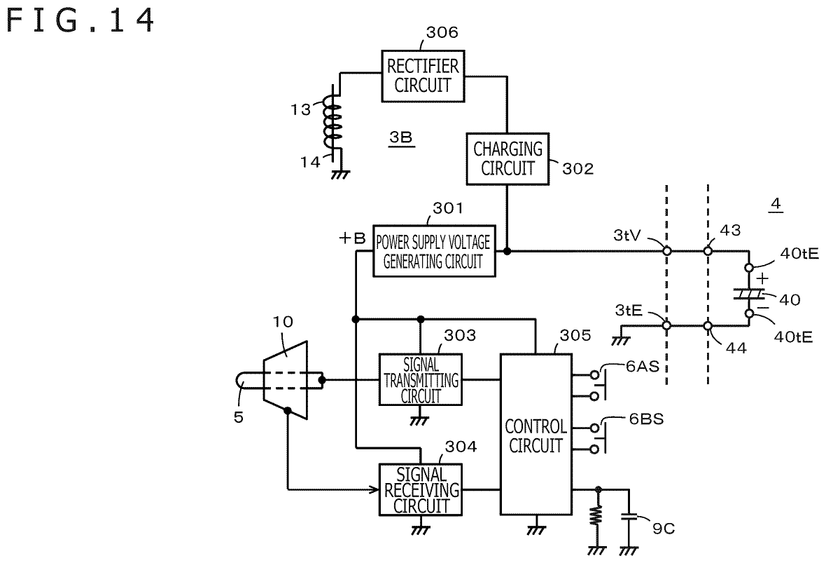

FIG. 14 illustrates an example of a circuit configuration in the electronic pen main body 3B according to the present third embodiment. As illustrated in this FIG. 14, in the electronic pen main body 3B according to the present third embodiment, one end of the coil 13 is coupled to the charging circuit 302 through a rectifier circuit 306. Then, another end of the coil 13 is coupled to the grounding conductor. The other circuit configuration is similar to that of the electronic pen main body 3 of the electronic pen 1 according to the first embodiment.

The electronic pen 1B according to the third embodiment is provided with external alternating magnetic field generating means. An alternating magnetic field occurring from the alternating magnetic field generating means generates an electromagnetically induced current in the coil 13. This electromagnetically induced current is rectified by the rectifier circuit 306. The rectified current is supplied as a charging current to the charging circuit 302. The charging circuit 302 charges the battery cell(s) of the battery 40 of the power supply 4 with the charging current.

Moreover, in the present third embodiment, as illustrated in FIG. 13, an electronic pen casing 2B is constituted by a pen tip side casing 21B and a rear end side casing 22B, and the two casings are configured to be screwed to each other in the vicinity of a center in the axial direction of the electronic pen casing 2B. In the present example, as illustrated in FIG. 13, a small-diameter portion 21Ba having an outside diameter smaller than the diameter on the pen tip side of the pen tip side casing 21B is formed on the rear end side of the pen tip side casing 21B, and the small-diameter portion 21Ba is provided with a threaded portion 21Bs. In this case, a rear end of the small-diameter portion 21Ba of the pen tip side casing 21B is at a position in the vicinity of the end surface 3s on the rear end side of the electronic pen main body 3B. In the example of FIG. 13, the rear end of the small-diameter portion 21Ba of the pen tip side casing 21B is at a position slightly extended to the rear end side from the end surface 3s on the rear end side of the electronic pen main body 3B, and is configured such that a part of the pen tip side of the power supply 4 can be housed within the small-diameter portion 21Ba.

The rear end side casing 22B has an inside diameter slightly larger than the outside diameter of the small-diameter portion 21Ba of the pen tip side casing 21B. The small-diameter portion 21Ba of the pen tip side casing 21B is inserted into the rear end side casing 22B. Moreover, an inner wall of a part of the rear end side casing 22B which part covers the small-diameter portion 21Ba of the pen tip side casing 21B is provided with a threaded portion 22Bs screwed to the threaded portion 21Bs of the small-diameter portion 21Ba. Moreover, an elastic member 25 formed of an elastic material, or an elastic rubber in the present example, is attached to a bottom portion on the rear end side of a hollow portion of the rear end side casing 22B.

In the electronic pen 1B according to the present third embodiment, the rear end side casing 22B internally housing the power supply 4 is screwed to the rear end side of the pen tip side casing 21B housing the electronic pen main body 3B. Then, within a hollow portion of the electronic pen casing 2B, the electronic pen main body 3B and the power supply 4 are housed in a state of being sequentially arranged in the axial direction. In this case, within the hollow portion of the electronic pen casing 2B, the elastic member 25 attached to the rear end side casing 22B presses and biases the power supply 4 to the electronic pen main body 3B side, and thereby brings the end surface 3s of the electronic pen main body 3B and the end surface 4s of the power supply 4 into elastic pressure contact with each other. Therefore, as in the foregoing first embodiment, the terminals provided to the end surface 3s on the rear end side of the electronic pen main body 3B and the end surface 4s on the pen tip side of the power supply 4 are electrically securely coupled to each other.

Then, the electronic pen casing 2B is separated into the pen tip side casing 21B and the rear end side casing 22B by unscrewing the rear end side casing 22B and the pen tip side casing 21B from each other. When the rear end side casing 22B is separated from the pen tip side casing 21B, the power supply 4 is separated from the electronic pen main body 3B together with the rear end side casing 22B, and the power supply 4 can be easily extracted from the rear end side casing 22B. That is, by unscrewing the rear end side casing 22B and the pen tip side casing 21B from each other, it is possible to extract the power supply 4 from the electronic pen 1B easily, and replace the power supply 4 easily.

It is to be noted that, as with the elastic member 24 in the second embodiment, the elastic member 25 is not limited to elastic rubber, but may have a configuration of a leaf spring member or a coil spring. Moreover, instead of being attached to the rear end side casing 22B, the elastic member 25 may be configured to be interposed as a separate independent member between the rear end side casing 22B and the power supply 4 within the rear end side casing 22B.

In addition, while the electronic pen 1B according to the foregoing third embodiment is configured to use the electronic pen main body 3B having a configuration that charges the power supply 4 by electromagnetic induction, the electronic pen main body 3 that charges the power supply 4 by using the charging current externally obtained through the USB connector 7UC may be used in place of the electronic pen main body 3B.

Conversely, the electronic pen 1 according to the foregoing first embodiment and the electronic pen 1A according to the second embodiment can be configured to use the electronic pen main body 3B in place of the electronic pen main body 3.

In addition, the electronic pen 1B according to the foregoing third embodiment has a configuration that couples and locks the pen tip side casing 21B and the rear end side casing 22B to each other by screwing the two casings to each other. However, the configuration that couples and locks the two casings to each other is not limited to such a configuration. For example, a configuration may be adopted in which a ring-shaped protrusion or recess is provided to a peripheral side surface of the small-diameter portion 21Ba of the pen tip side casing 21B, a ring-shaped recess or protrusion to be fitted to the ring-shaped protrusion or recess on the peripheral side surface of the small-diameter portion 21Ba of the pen tip side casing 21B is formed on an inner wall surface of the rear end side casing 22B, the ring-shaped recess or protrusion on the inner wall surface of the rear end side casing 22B is fitted to the ring-shaped protrusion or recess on the peripheral side surface of the small-diameter portion 21Ba of the pen tip side casing 21B by pushing the rear end side casing 22B onto the pen tip side casing 21B, and thereby the two casings are coupled and locked to each other.

### Fourth Embodiment

The electronic pens 1, 1A, and 1B according to the foregoing first to third embodiments have a structure such that when the electronic pen casing 2, 2A, or 2B is separated into the pen tip side and the rear end side, the electronic pen main body 3, 3A, or 3B and the power supply 4 are automatically separated from each other both electrically and physically. On the other hand, an electronic pen 1C according to a fourth embodiment to be described in the following represents an example of a structure such that an electronic pen main body 3C and the power supply 4 maintains an electrically and physically coupled state when an electronic pen casing 2C is merely separated into a pen tip side and a rear end side, but the power supply 4 can be separated from the electronic pen main body 3C and extracted easily by an extracting operation of a user.

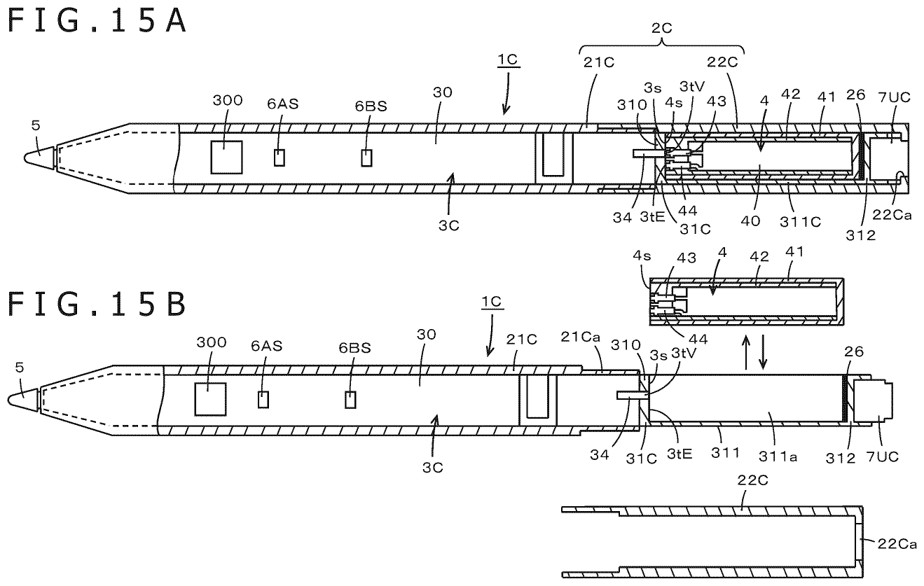

FIGS. 15A and 15B are diagrams illustrating a configuration of the electronic pen 1C according to the present fourth embodiment. Also in the present example, as in the foregoing embodiments, parts similar to constituent parts of the first embodiment are provided with the same reference signs, and a detailed description thereof will be omitted. FIG. 15A is a longitudinal sectional view of the electronic pen 1C according to the present fourth embodiment. FIG. 15A corresponds to FIG. 2A illustrating an example of configuration of the electronic pen 1 according to the foregoing first embodiment. In addition, FIG. 15B is a diagram illustrating a configuration in which the power supply 4 is extracted after the electronic pen casing 2C is separated into a pen tip side and a rear end side.

As illustrated in FIGS. 15A and 15B, as in the electronic pen casing 2B of the electronic pen 1B according to the third embodiment, the electronic pen casing 2C of the electronic pen 1C according to the present fourth embodiment is constituted by a pen tip side casing 21C and a rear end side casing 22C, and the two casings are configured to be coupled to each other in the vicinity of a center in the axial direction of the electronic pen casing 2C. Also in the present example, a small-diameter portion 21Ca is formed on the rear end side of the pen tip side casing 21C. This small-diameter portion 21Ca is inserted into a hollow portion of the rear end side casing 22C. The pen tip side casing 21C and the rear end side casing 22C are thereby coupled to each other to form the electronic pen casing 2C.

In this case, a mode of coupling between the pen tip side casing 21C and the rear end side casing 22C may be screwing as in the electronic pen casing 2B according to the third embodiment, or may be a configuration in which one casing is provided with a ring-shaped protrusion or recess, the other casing is provided with a recess or a protrusion to be fitted to the ring-shaped protrusion or recess provided to the one casing, and the recess or the protrusion is fitted to the ring-shaped protrusion or recess. Also in the present example, the position of an end surface on the rear end side of the small-diameter portion 21Ca of the pen tip side casing 21C is in the vicinity of the position of the end surface 3s of the wall 310.

A holder 31C of the electronic pen main body 3C in the electronic pen 1C according to the present fourth embodiment has a configuration similar to that of the foregoing embodiments in which configuration the holder 31C has the wall 310 on the rear end side of the mounting portion for the circuit board 30, and the circular end surface of the wall 310 is formed as the end surface 3s that abuts against the end surface 4s of the power supply 4. Moreover, the holder 31C of the electronic pen main body 3C in the present embodiment is further extended to the rear end side from the wall 310, and includes a housing portion 311 for the power supply 4 as the extended portion. The housing portion 311 for the power supply 4 has a housing space 311a of a length slightly longer than the length in the axial direction of the power supply 4 in a cylindrical shape. Moreover, an elastic member 26 is attached to the rear end side of the housing space 311a of the housing portion 311. This elastic member 26 in the present example is formed of an elastic rubber. Incidentally, the elastic member 26 is not limited to elastic rubber, but may be a leaf spring, a coil, or the like, as with the elastic members 24 and 25 in the electronic pens 1A and 1B according to the second embodiment and the third embodiment.

Moreover, in the electronic pen 1C according to the present fourth embodiment, the holder 31C is further extended to the rear end side from the housing portion 311, and is provided with a holding portion 312 for the USB connector 7UC as the extended portion. As illustrated in FIGS. 15A and 15B, the USB connector 7UC (for example, a connector jack) in the present example is held and fixed by the holding portion 312 such that an external USB connector (for example, a connector plug) is inserted from the rear end side in the axial direction of the electronic pen casing 2C. Though not illustrated in FIGS. 15A and 15B, an electric connection between the USB connector 7UC and the circuit board 30 is made via the housing portion 311. For example, the electric connection is made by providing the inner wall surface of the housing space or the outer wall surface of the housing portion 311 with a copper foil pattern by printing or the like.

Because the USB connector 7UC is provided to an end portion on the rear end side of the electronic pen casing 2C, an end portion on the rear end side of the rear end side casing 22C is provided with a through hole 22Ca for exposing a connector portion of the USB connector 7UC to the outside, as illustrated in FIGS. 15A and 15B.

In the electronic pen 1C according to the present embodiment, as illustrated in FIG. 15B, in a state in which the pen tip side of the electronic pen main body 3C is housed within a hollow portion of the pen tip side casing 21C, the housing portion 311 for the power supply 4 in the holder 31C is exposed to the outside on the rear end side of the pen tip side casing 21C. Therefore, as illustrated in FIG. 15B, the power supply 4 can be housed into the housing space 311a of the housing portion 311 from the direction orthogonal to the axial direction.

In the housed state of the power supply 4 in the housing portion 311, the elastic member 26 provided to the rear end side of the housing portion 311 elastically biases the power supply 4 to the end surface 3s side of the wall 310 of the electronic pen main body 3C. Therefore, the terminal 3tV and the terminal 3tE on the end surface 3s of the electronic pen main body 3C and the electrode pins (pogo pins) 43 and 44 protruding from the end surface 4s of the power supply 4 are electrically securely in contact with each other, and the power supply 4 is also physically locked to the housing portion 311.

When the rear end side casing 22C is coupled to the pen tip side casing 21C in this state, the state illustrated in FIG. 15A can be set, and the electronic pen 1C can be thus formed.

Then, in the electronic pen 1C illustrated in FIG. 15A, when the rear end side casing 22C and the pen tip side casing 21C are uncoupled from each other, and the rear end side casing 22C is removed from the pen tip side casing 21C, as illustrated in FIG. 15B, the power supply 4 housed in the housing portion 311 of the holder 31C of the electronic pen main body 3C is exposed to the outside, as described above. Hence, the power supply 4 can be extracted from the housing portion 311 in the direction orthogonal to the axial direction, and the power supply 4 can be replaced. Incidentally, in the electronic pen 1C according to the fourth embodiment in the example of FIGS. 15A and 15B, the USB connector 7UC is configured to be provided in the end portion on the rear end side of the housing portion 311 for the power supply 4 in the electronic pen casing 2C.

However, the USB connector 7UC may be configured to be provided on the pen tip side of the power supply 4 by providing a configuration in which, as in the electronic pen main body 3 according to the first embodiment, the circuit board 30 is provided with a notch portion, and the USB connector 7UC is coupled to the external USB connector from the opening 7 in the side circumferential surface of the electronic pen casing 2C.

In addition, while the electronic pen main body 3C has a configuration including the USB connector 7UC as a configuration for charging the power supply 4, the electronic pen main body 3C may have a configuration including an electromagnetic induction coil and uses an induced current thereof as the charging current, as in the case of the electronic pen main body 3B of the electronic pen 1B according to the third embodiment.

### Fifth Embodiment

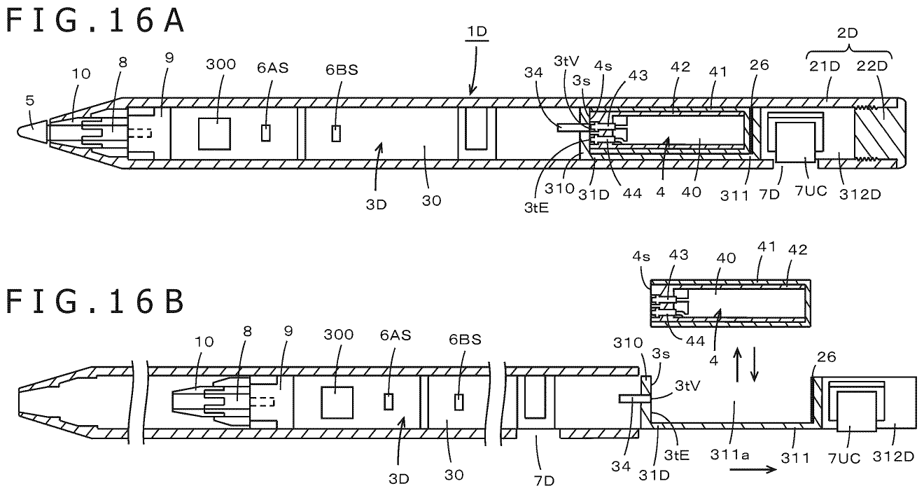

FIGS. 16A and 16B are diagrams illustrating a configuration of an electronic pen 1D according to a fifth embodiment. FIG. 16A is a longitudinal sectional view of the electronic pen 1D according to the present fifth embodiment. FIG. 16A corresponds to FIG. 15A illustrating an example of configuration of the electronic pen 1C according to the foregoing fourth embodiment. In addition, FIG. 16B is a diagram illustrating a configuration in which the power supply 4 is extracted after an electronic pen casing 2D of the electronic pen 1D according to the present fifth embodiment is separated into a pen tip side and a rear end side. Incidentally, in the electronic pen 1D according to the fifth embodiment illustrated in FIGS. 16A and 16B, parts similar to those of the electronic pen 1C according to the fourth embodiment illustrated in FIGS. 15A and 15B are identified by the same reference signs, and a detailed description thereof will be omitted.

As illustrated in FIGS. 16A and 16B, as in the holder 31C of the electronic pen main body 3C of the electronic pen 1C according to the foregoing fourth embodiment, a holder 31D of an electronic pen main body 3D of the electronic pen 1D according to the present fifth embodiment is further extended to the rear end side from the wall 310, and includes the housing portion 311 having the housing space 311a for the power supply 4 as the extended portion. Then, the power supply 4 is housed in the housing space 311a of the housing portion 311 in a state in which the power supply 4 is elastically biased to the wall 310 side of the holder 31D of the electronic pen main body 3D by the elastic member 26. Thus, also in the present fifth embodiment, the terminal 3tV and the terminal 3tE on the end surface 3s of the electronic pen main body 3D and the electrode pins (pogo pins) 43 and 44 protruding from the end surface 4s of the power supply 4 are electrically securely in contact with each other, and the power supply 4 is also physically locked to the housing portion 311. Moreover, also in the electronic pen 1D according to the present fifth embodiment, the holder 31D is further extended to the rear end side from the housing portion 311, and is provided with a holding portion 312D for the USB connector 7UC as the extended portion. However, in the present fifth embodiment, unlike the fourth embodiment, as illustrated in FIGS. 16A and 16B, the USB connector 7UC (for example, a connector jack) in the present example is held and fixed by the holding portion 312D such that an external USB connector (for example, a connector plug) is inserted from a direction orthogonal to the axial direction of the electronic pen casing 2D. Though not illustrated in FIGS. 16A and 16B, an electric connection between the USB connector 7UC and the circuit board 30 is made via the housing portion 311. For example, the electric connection is made by providing the inner wall surface of the housing space or the outer wall surface of the housing portion 311 with a copper foil pattern by printing or the like, as in the fourth embodiment.

As illustrated in FIGS. 16A and 16B, as in the electronic pen casing 2A of the electronic pen 1A according to the second embodiment, the electronic pen casing 2D of the electronic pen 1D according to the present fifth embodiment is constituted by a casing main body 21D and a cap 22D, and the electronic pen casing 2D is configured to be formed by screwing the cap 22D into the casing main body 21D.

In the present fifth embodiment, because the USB connector 7UC is provided so as to be held by the holding portion 312D as described above, an opening 7D for exposing the connector portion of the USB connector 7UC to the outside is provided in the vicinity of the rear end side of a side circumferential surface of the casing main body 21D of the electronic pen casing 2D, as illustrated in FIGS. 16A and 16B.

In the electronic pen 1D according to the present fifth embodiment, after the power supply 4 is housed in the housing portion 311 of the holder 31D of the electronic pen main body 3D, the electronic pen main body 3D in a state in which the power supply 4 is housed in the holder 31D is inserted into the casing main body 21D from an opening on the rear end side of the casing main body 21D. In this state, the electronic pen main body 3D in a state in which the power supply 4 is housed in the holder 31D is movable in the axial direction within a hollow portion of the casing main body 21D.

Then, in the present fifth embodiment, the holder 31D of the electronic pen main body 3D is made immovable in the axial direction in a hollow portion of the electronic pen casing 2D by thereafter screwing the cap 22D into the casing main body 21D. Incidentally, an elastic member such as an elastic rubber may be provided between an end portion on the pen tip side of the cap 22D and an end portion on the rear end side of the holder 31D of the electronic pen main body 3D.

In the electronic pen 1D according to the present fifth embodiment, the power supply 4 can be extracted from the electronic pen casing 2D and replaced as follows. First, in a state illustrated in FIG. 16A, the casing main body 21D and the cap 22D are unscrewed from each other, and the cap 22D is removed from the casing main body 21D. Then, the electronic pen main body 3D in a state in which the power supply 4 is housed in the holder 31D becomes movable in the axial direction within the hollow portion of the casing main body 21D. Thus, as illustrated in FIG. 16B, the housing portion 311 housing the power supply 4 in the holder 31D of the electronic pen main body 3D can be drawn out to the outside from an end portion on the rear end side of the casing main body 21D.

Hence, the power supply 4 can be easily extracted in the direction orthogonal to the axial direction from the housing portion 311 drawn out to the outside, and can be easily replaced. Incidentally, in the electronic pen 1D according to the fifth embodiment in the example of FIGS. 16A and 16B, the USB connector 7UC is configured to be provided in an end portion on the rear end side of the housing portion 311 for the power supply 4 in the electronic pen casing 2D. However, as in the electronic pen main body 3 according to the first embodiment, the USB connector 7UC may be configured to be provided on the pen tip side of the power supply 4 by providing a configuration in which the circuit board 30 is provided with a notch portion, and the USB connector 7UC is coupled with the external USB connector from the opening 7 in the side circumferential surface of the casing 2D.

In addition, while the electronic pen main body 3D has a configuration including the USB connector 7UC as a configuration for charging the power supply 4, the electronic pen main body 3D may have a configuration including an electromagnetic induction coil and uses an induced current thereof as the charging current, as in the case of the electronic pen main body 3B of the electronic pen 1B according to the third embodiment.

Incidentally, in the electronic pen 1C according to the fourth embodiment and the electronic pen 1D according to the fifth embodiment, the holders 31C and 31D of the electronic pen main bodys 3C and 3D are configured to be extended to the rear end side to provide the housing portion 311 for the power supply 4. However, a holder having the housing portion for the power supply 4 may be formed separately from the holders 31C and 31D. In that case, the holder including the housing portion for the power supply is configured to be arranged in the axial direction with respect to the holders 31C and 31D of the electronic pen main bodys 3C and 3D having no extended portion.

### Sixth Embodiment

In the electronic pens 1, 1A, 1B, 1C, and 1D according to the foregoing embodiments, the electronic pen casing 2, 2A, 2B, 2C, or 2D is separated into the pen tip side and the rear end side by separating the pen tip side casing part (the casing main body 21, 21A, or 21D or the pen tip side casing 21B or 21C) and the rear end side casing part (the cap 22, 22A, or 22D or the rear end side casing 22B or 22C) constituting the electronic pen casing 2, 2A, 2B, 2C, or 2D from each other, and the power supply 4 is extracted from the electronic pen casing 2, 2A, 2B, 2C, or 2D of the electronic pen 1, 1A, 1B, 1C, or 1D.

However, in a case where a disposal company disposes of a large number of electronic pens, for example, work of separating the electronic pens into the pen tip side casing parts (the casing main body 21, 21A, or 21D or the pen tip side casing 21B or 21C) and the rear end side casing parts (the cap 22, 22A, or 22D or the rear end side casing 22B or 22C) as described above may be troublesome.

An electronic pen according to a present sixth embodiment is configured to allow an electronic pen casing to be relatively easily separated into a pen tip side and a rear end side by a simple operation. The sixth embodiment can be applied to each of the first to fifth electronic pens 1 to 1D described above. A feature of a configuration of the sixth embodiment is that the electronic pen casing 2, 2A, 2B, 2C, or 2D is configured to be capable of being easily separated into a pen tip side and a rear end side of a predetermined intermediate position in the axial direction of the electronic pen casing 2, 2A, 2B, 2C, or 2D by applying a force to the electronic pen casing 2, 2A, 2B, 2C, or 2D so as to break the electronic pen casing 2, 2A, 2B, 2C, or 2D at the predetermined intermediate position.

In this case, the predetermined intermediate position in the present embodiment is a position in the vicinity of a position corresponding to a position at which the end surface 3s of the electronic pen main body 3, 3A, 3B, 3C, or 3D housed within the electronic pen casing 2, 2A, 2B, 2C, or 2D and the end surface 4s of the power supply 4 abut against each other in the axial direction of the outer circumferential side surface of the electronic pen casing 2, 2A, 2B, 2C, or 2D.

In the present embodiment, a thickness at the predetermined intermediate position of the electronic pen casing 2, 2A, 2B, 2C, or 2D is reduced by providing a recess in the circumferential direction of the outer circumferential side surface at the predetermined intermediate position in the axial direction of the outer circumferential side surface of the electronic pen casing 2, 2A, 2B, 2C, or 2D. The electronic pen casing 2, 2A, 2B, 2C, or 2D is thereby made easier to break. However, the recess is provided after, for example, the shape, width, or depth (thickness of the thin part) of the recess is selected such that the electronic pen casing 2, 2A, 2B, 2C, or 2D has an appropriate strength without being broken in a normal usage state of the electronic pen 1, 1A, 1B, 1C, or 1D even though the electronic pen casing 2, 2A, 2B, 2C, or 2D is made easier to break.

In addition, while the recess may be provided in a ring shape with uniform shape, width, and depth at the predetermined intermediate position in the axial direction of the outer circumferential side surface of the electronic pen casing 2, 2A, 2B, 2C, or 2D, the recess may be formed nonuniformly by changing one or two or more of the shape, the width, and the depth when formed in a ring shape in consideration of the strength of the electronic pen 1, 1A, 1B, 1C, or 1D in the normal usage state. In addition, the recess may be formed in a ring shape at discrete positions rather than being continuously formed in a ring shape. Further, the recess may be formed in a part of ring shape positions such as a part corresponding to a semi-circumference.

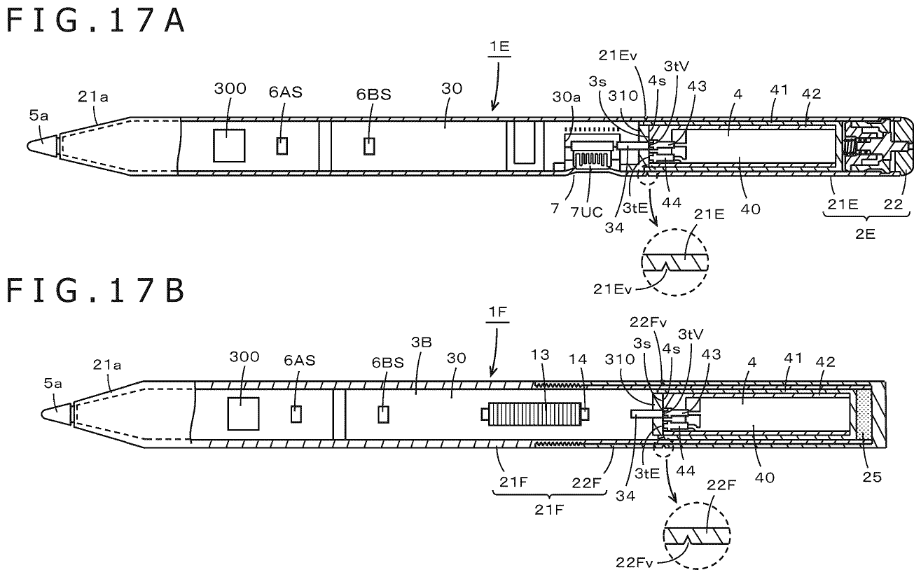

FIG. 17A is a diagram illustrating an electronic pen 1E in a case where the sixth embodiment is applied to the electronic pen 1 according to the foregoing first embodiment. In FIG. 17A, parts similar to those of the electronic pen 1 according to the foregoing first embodiment are identified by the same reference signs, and a description thereof will be omitted. The electronic pen 1E in the present example is different from the electronic pen 1 according to the first embodiment in that, as illustrated in FIG. 17A, a casing main body 21E that is coupled to the cap 22 to constitute an electronic pen casing 2E has a ring-shaped V-groove 21Ev as an example of the recess in an outer circumferential side surface of the casing main body 21E. The electronic pen 1E is otherwise configured in a similar manner to the electronic pen 1 according to the first embodiment.

As illustrated in FIG. 17A, for the ring-shaped V-groove 21Ev, the above-described predetermined intermediate position in the axial direction of the outer circumferential side surface of the casing main body 21E constituting the electronic pen casing 2E is a position in the vicinity of a position corresponding to a position at which the end surface 3s of the electronic pen main body 3 housed within the casing main body 21E and the end surface 4s of the power supply 4 abut against each other. Moreover, as illustrated in a callout in FIG. 17A, the part of the V-groove 21Ev is made thin, and is formed with such a width and depth as to have a sufficient strength during normal usage. In the electronic pen 1E thus formed, when, for example, one position side of positions on both sides of the V-groove 21Ev in the axial direction of the casing main body 21E having the V-groove 21Ev formed thereon is fixed, and a strong force in the direction orthogonal to the axial direction is applied to the other position side, the casing main body 21E is broken so as to be ruptured at the part of the V-groove 21Ev, and is separated into a part on the pen tip side of the V-groove 21Ev and a part on the rear end side of the V-groove 21Ev, because the part of the V-groove 21Ev is thin and is low in strength.

Then, because the electronic pen main body 3 and the power supply 4 within the casing main body 21E of the electronic pen 1E in the present example are not physically coupled to each other, the power supply 4 is extracted to the outside. That is, the electronic pen 1E in the present example allows the power supply 4 to be extracted by breaking and rupturing the casing main body 21E at the part of the V-groove 21Ev. It is therefore easy to extract and dispose of the power supply 4 at a time of disposing of the electronic pen 1E.

As with the electronic pen 1E in the example of FIG. 17A, the electronic pen 1A according to the second embodiment in which the electronic pen casing 2A is constituted by the casing main body 21A and the cap 22A and the electronic pen 1D according to the fifth embodiment in which the electronic pen casing 2D is constituted by the casing main body 21D and the cap 22D can also be provided with a recess, for example, a V-groove, at the above-described predetermined intermediate position in the axial direction of the outer circumferential side surface of the casing main body 21A or 21D, so that the power supply 4 can be extracted by breaking and rupturing the casing main body 21A or 21D at the part of the V-groove. It is therefore easy to extract and dispose of the power supply 4 at a time of disposing of the electronic pen 1A or 1D.

FIG. 17B is a diagram illustrating an electronic pen 1F in a case where the sixth embodiment is applied to the electronic pen 1B according to the foregoing third embodiment. In this FIG. 17B, parts similar to those of the electronic pen 1B according to the foregoing third embodiment are identified by the same reference signs, and a description thereof will be omitted. The electronic pen 1F in the present example is different from the electronic pen 1B according to the third embodiment in that, as illustrated in FIG. 17B, a rear end side casing 22F that is coupled to the pen tip side casing 21B to constitute an electronic pen casing 2F has a ring-shaped V-groove 22Fv as an example of the recess in an outer circumferential side surface of the rear end side casing 22F. The electronic pen 1F is otherwise configured in a similar manner to the electronic pen 1B according to the third embodiment.

As illustrated in FIG. 17B, for the ring-shaped V-groove 22Fv, the above-described predetermined intermediate position of the outer circumferential side surface of the rear end side casing 22F constituting the electronic pen casing 2F is a position in the vicinity of a position corresponding to a position at which the end surface 3s of the electronic pen main body 3 within the rear end side casing 22F and the end surface 4s of the power supply 4 abut against each other. Moreover, as illustrated in a callout in FIG. 17B, the part of the V-groove 22Fv is made thin, and is formed with such a width and depth as to have a sufficient strength during normal usage.

Also in the electronic pen 1F thus formed, when, for example, one position side of positions on both sides of the V-groove 22Fv in the axial direction of the electronic pen casing 2F having the V-groove 22Fv formed on the rear end side casing 22F is fixed, and a strong force in the direction orthogonal to the axial direction is applied to the other position side, the electronic pen casing 2F is broken so as to be ruptured at the part of the V-groove 21Ev, and is separated into a part on the pen tip side of the V-groove 22Fv and a part on the rear end side of the V-groove 22Fv, because the part of the V-groove 22Fv of the rear end side casing 22F is thin and is low in strength.

Then, because the electronic pen main body 3B and the power supply 4 within the electronic pen casing 2F of the electronic pen 1F in the present example are not physically coupled to each other, the power supply 4 is extracted to the outside. That is, the electronic pen 1F in the present example also allows the power supply 4 to be extracted by breaking and rupturing the electronic pen casing 2F at the part of the V-groove 21Ev. It is therefore easy to extract and dispose of the power supply 4 at a time of disposing of the electronic pen 1F.

As with the electronic pen IF in the example of FIG. 17B, the electronic pen 1C according to the fourth embodiment in which the electronic pen casing 2C is constituted by the pen tip side casing 21C and the rear end side casing 22C can also be provided with a recess, for example, a V-groove, at the above-described predetermined intermediate position in the axial direction of the outer circumferential side surface of the rear end side casing 22C, so that the power supply 4 can be extracted by breaking and rupturing the electronic pen casing 2C at the part of the V-groove. It is therefore easy to extract and dispose of the power supply 4 at a time of disposing of the electronic pen 1C.

It is to be noted that while the shape of the recess is a V-shaped groove in the examples of FIGS. 17A and 17B, the shape of the recess is not limited to the V-shape, as described earlier, but may be, for example, a U-shape or another shape.

In addition, in a case where the electronic pen according to the sixth embodiment is configured such that the power supply 4 does not need to be replaced, the pen tip side casing part (the casing main body 21, 21A, or 21D or the pen tip side casing 21B or 21C) and the rear end side casing part (the cap 22, 22A, or 22D or the rear end side casing 22B or 22C) may be coupled to each other by bonding or the like.

### Other Examples of Electric Connection Between Electronic Pen Main Body and Power Supply

In the configurations of the electronic pens according to the foregoing embodiments, the electronic pen main body and the power supply are provided so as to be arranged in the axial direction within the casing, and are configured such that the end surface on the rear end side of the electronic pen main body and the end surface on the pen tip side of the power supply abut against each other to make an electric connection between the electronic pen main body and the power supply. However, a method of the electric connection between the electronic pen main body and the power supply is not limited to this.

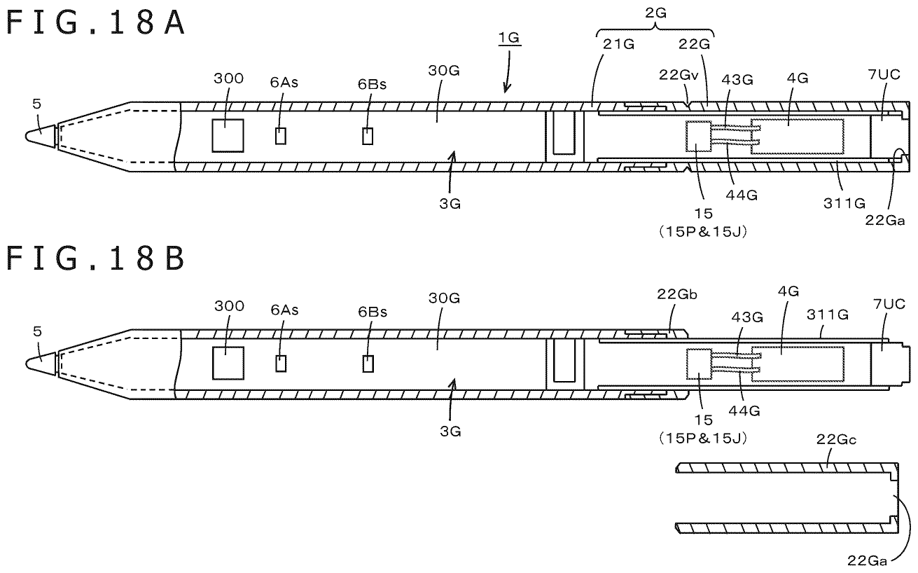

In an electronic pen 1G in an example of FIGS. 18A and 18B, an electronic pen main body 3G and a power supply 4G are electrically coupled to each other by coupling a connector (a connector plug or a connector jack) of the power supply 4G to a connector (a connector jack or a connector plug) disposed on a circuit board 30G mounted in a holder 31G of the electronic pen main body 3G.

FIGS. 18A and 18B are diagrams illustrating a configuration of the electronic pen 1G in the present example. FIG. 18A is a longitudinal sectional view of the electronic pen 1G in the present example. In addition, FIG. 18B is a diagram illustrating a configuration in which the power supply 4G is extracted after an electronic pen casing 2G of the electronic pen 1G in the present example is separated into a pen tip side and a rear end side. Incidentally, in FIGS. 18A and 18B, parts similar to those of the electronic pens according to the foregoing embodiments are identified by the same reference signs, and a detailed description thereof will be omitted.

In the electronic pen 1G in the present example, as illustrated in FIG. 18A, the electronic pen casing 2G is constituted by a pen tip side casing 21G and a rear end side casing 22G, and the two casings are configured to be coupled to each other in the vicinity of a center in the axial direction of the electronic pen casing 2G.

Moreover, the electronic pen 1G in the example of FIGS. 18A and 18B has a configuration to which the sixth embodiment is applied. Thus, a circumferential recess, or a V-groove 22Gv in the present example is formed at a predetermined position in the axial direction of an outer circumferential side surface of the rear end side casing 22G. In this case, the pen tip side casing 21G and the rear end side casing 22G may be coupled to each other by screwing, or may be coupled to each other by fitting a ring-shaped protrusion and a ring-shaped recess to each other. In addition, in a case of a configuration in which the power supply 4G does not need to be replaced, the pen tip side casing 21G and the rear end side casing 22G may be coupled to each other by bonding or the like.

As with the electronic pen main body 3 of the electronic pen 1 according to the foregoing first embodiment, the electronic pen main body 3G of the electronic pen 1G in the present example is provided with a circuit board 30G in a board mounting portion of a holder 311G, has an IC 300 on the circuit board 30G, has side switches 6AS and 6BS, and includes a pen tip side constituent unit as illustrated in FIG. 3. However, the holder 311G of the electronic pen 1G in the present example is configured to be extended to the rear end side of the electronic pen casing 2G, that is, into the rear end side casing 22G. The circuit board 30G held in the holder 311G is also extended to the rear end side of the electronic pen casing 2G.

Moreover, in the electronic pen 1G in the present example, a rear end of the circuit board 30G is provided with a USB connector 7UC constituting a charging terminal. A rear end surface of the rear end side casing 22G is provided with an opening 22Ga for exposing a connector coupling portion of the USB connector 7UC.

In addition, in the electronic pen 1G in the present example, a connector jack 15J in the present example of a connector 15 for electric connection to the power supply 4G is provided at a position closest to the pen tip side casing 21G on a part of the circuit board 30G which part is located within the rear end side casing 22G.

The power supply 4G in the present example has a similar configuration to that of the power supply 4 described above except only for a different configuration in a terminal portion. That is, the power supply 4G in the present example is not provided with the pogo pins 43 and 44, but is instead configured such that the electrode terminals 40tV and 40tE of the battery 40 are coupled to lead portions 43G and 44G, and the lead portions 43G and 44G are coupled to a connector plug 15P in the present example of the connector 15.

Moreover, in the electronic pen 1G in the present example, as illustrated in FIG. 18A, in a state in which the power supply 4G is placed between the USB connector 7UC and the connector jack 15J on the circuit board 30G, the connector plug 15P coupled with the lead portions 43G and 44G of the power supply 4G is inserted into and electrically coupled to the connector jack 15J on the circuit board 30G.

As illustrated in FIG. 18A, the length in the axial direction of a hollow space of the rear end side casing 22G of the electronic pen 1G in the present example is such a length as to be capable of housing the connector 15, the power supply 4G, and the USB connector 7UC. Moreover, as illustrated in FIGS. 18A and 18B, a rear end side of the circuit board 30G which rear end side is rearward of a part where the connector jack 15J is formed is configured to be more to the rear end side than an end portion on the rear end side of the pen tip side casing 21G. That is, the rear end side of the circuit board 30G which rear end side is rearward of the part where the connector jack 15J is formed is configured to be exposed to the outside in a state in which the rear end side casing 22G is not coupled to the pen tip side casing 21G.

A position in the axial direction at which position the V-groove 22Gv of the outer circumferential side surface of the rear end side casing 22G is formed is a position such that, as illustrated in FIGS. 18A and 18B, when the rear end side casing 22G is ruptured and separated at the position of the V-groove 22Gv, the connector jack 15J provided to the circuit board 30G is exposed to the outside, and the connector plug 15P can be removed from the connector jack 15J. In the example of FIGS. 18A and 18B, the V-groove 22Gv is formed at a position coinciding with a position nearest to the pen tip side of the connector jack 15J provided to the circuit board 30G. Incidentally, the position of the V-groove 22Gv is preferably the position most to the pen tip side of the connector jack 15J or a position more to the pen tip side than the position most to the pen tip side of the connector jack 15J.

Because the electronic pen 1G in the present example is configured as described above, when such a force as to break the electronic pen casing 2G at the part of the V-groove 22Gv is applied to the electronic pen casing 2G, the rear end side casing 22G is ruptured at the position of the V-groove 22Gv and separated into a part 22Gb on the pen tip side of the V-groove 22Gv and a part 22Gc on the rear end side of the V-groove 22Gv, and a part of the circuit board 30G which part is on the rear end side of the part of the connector 15 is exposed, as illustrated in FIG. 18B. Hence, the power supply 4G can be separated and extracted by removing the connector plug 15P coupled with the power supply 4G from the connector 15.

Incidentally, in a case where the rear end side casing 22G is configured to be capable of being uncoupled from the pen tip side casing 21G, it is possible to separate and extract the power supply 4G as in the foregoing, and replace the power supply 4G by uncoupling the rear end side casing 22G from the pen tip side casing 21G, as in the foregoing embodiments.

Incidentally, also in the electronic pen 1G in the example of FIGS. 18A and 18B, the USB connector 7UC may be provided on the pen tip side of the power supply 4G, or an electromagnetic induction coil can be provided in place of the USB connector 7UC to perform charging externally on a noncontact basis.

### Modifications of Cap

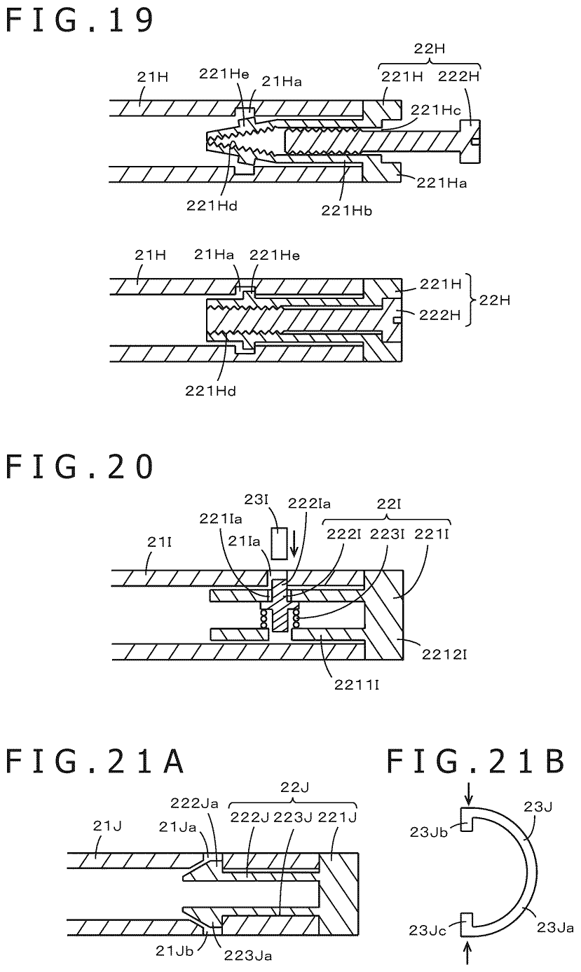

The cap that is detachably coupled to the casing main bodys 21 and 21E in the electronic pens according to the foregoing embodiments is not limited to the configuration of the cap 22 described above. FIGS. 19 to 21A illustrate other examples of the configuration of the cap that is detachably coupled to the casing main bodys 21 and 21E.

A cap 22H in an example of FIGS. 19A and 19B is formed of an elastic material, or resin in the present example, and is constituted by a cap main body 221H and a threaded member 222H. FIG. 19A is a diagram illustrating a state before the cap 22H in the present example is attached and fixed to a casing main body 21H. FIG. 19B is a diagram illustrating a state in which the cap 22H is attached and fixed to the casing main body 21H.

The cap main body 221H includes a cap head 221Ha and an inserter 221Hb that is inserted into a hollow portion of the casing main body 21H. The cap main body 221H is provided with a through hole 221Hc at a central position thereof. This through hole 221Hc is a through hole into which to insert and screw the threaded member 222H. Moreover, within the through hole 221Hc, a threaded portion 221Hd that is screwed onto a threaded portion 222Ha of the threaded member 222H is formed at least in a narrowed part on a distal end side of the inserter 221Hb.

Moreover, as illustrated in FIG. 19A, a protrusion 221He projecting in a direction intersecting the axial direction is formed on the outer circumferential side surface of the narrowed part on the distal end side of the inserter 221Hb.

On the other hand, in the inner wall surface of the casing main body 21H that has the cap 22H coupled to a rear end side thereof, as illustrated in FIGS. 19A and 19B, a recess 21Ha in a ring shape in the present example is formed at such a position as to be engageable with the protrusion 221He of the inserter 221Hb of the cap main body 221H when the cap 22H is coupled to the rear end of the casing main body 21H.

The threaded member 222H is configured to include a screw head portion 22Ha and a threaded shaft portion 22Hb having a threaded portion 222Hc formed at least on a distal end side thereof. In the present example, the threaded shaft portion 22Hb is configured to have a same diameter, including the part of the threaded portion 222Hc.

In the present example, as illustrated in FIG. 19A, after the cap main body 221H of the cap 22H is fitted to the rear end side of the casing main body 21, the threaded member 222H is inserted and screwed into the through hole 221Hc of the cap main body 221H.

Then, as illustrated in FIG. 19B, the narrowed part of the inserter 221Hb in the cap main body 221H of the cap 22H is elastically spread in the direction intersecting the axial direction in response to the screwing of the threaded member 222H, and the protrusion 221He of the inserter 221Hb is engaged with the recess 21Ha of the casing main body 21H, so that the cap 22H is locked to the rear end side of the casing main body 21H.

Conversely, when the threaded member 222H is extracted from the cap main body 221H of the cap 22H, the engagement between the protrusion 221He of the inserter 221Hb and the recess 21Ha of the casing main body 21H is released, as illustrated in FIG. 19A, so that the cap 22H can be separated from the rear end of the casing main body 21H.

Next, a cap 22I in an example of FIG. 20 is constituted by a cap main body 221I, a locking control 222I, and a coil spring 223I that constitutes an example of the elastic member. The cap main body 221I has a configuration provided with a tubular unit 2211I and a cap head 2212I on one side in the axial direction of the tubular unit 2211I.

The locking control 222I is provided within a hollow portion of the tubular unit 2211I so as to be locked in a state of being pressed and displaced in a direction orthogonal to the axial direction by the coil spring 223I. In this case, a through hole 2211Ia into which one end portion 222Ia of the locking control 222I can be inserted is formed in the side circumferential surface of the tubular unit 2211I, and the locking control 222I is configured such that, due to an elastic displacement force of the coil spring 223I, the one end portion 222Ia further protrudes from the outer circumferential surface of the tubular unit 2211I through the through hole 2211Ia of the tubular unit 2211I.

Moreover, as illustrated in FIG. 20, a through hole 21Ia that the one end portion 222Ia of the locking control 222I of the cap 22I is inserted into and engaged with is formed in the inner wall surface of a casing main body 21I having the cap 22I coupled to a rear end side thereof.

The cap 22I in the present example is fitted by pushing the cap 22I into a rear end of the casing main body 21I in a state in which the one end portion 222Ia of the locking control 222I is not protruded from the outer circumferential surface of the tubular unit 2211I of the cap main body 221I. In this fitted state, due to the elastic displacement force of the coil spring 223I, the one end portion 222Ia of the locking control 222I of the cap 22I is inserted into and engaged with the through hole 21Ia of the casing main body 21I through the through hole 2211Ia of the tubular unit 2211I, so that the cap 22I is locked to the rear end side of the casing main body 21I.

The cap 22I thus fitted to the casing main body 21I is removed as follows. Specifically, in the present example, as illustrated in FIG. 20, a rod-shaped jig 23I is inserted into the through hole 21Ia of the casing main body 21I, and is pressed so as to house the one end portion 222Ia of the locking control 222I of the cap 22I into the tubular unit 2211I against the elastic force of the coil spring 223I.

Then, the engagement between the one end portion 222Ia of the locking control 222I and the through hole 21Ia of the casing main body 21I is released. Thus, when the cap head 2212I of the cap 22I is pulled in this state, the cap 22I can be separated from the rear end of the casing main body 21I.

Next, a cap 22J in an example of FIGS. 21A and 21B is formed as an integral object of resin having elasticity. As illustrated in FIG. 21A, the cap 22J in the present example is constituted by a cap head 221J and two insertion and engagement pieces 222J and 223J that are formed integrally with the cap head 221J, and are inserted into a hollow portion of a casing main body 21J and engaged with the casing main body 21J, as will be described later.

The two insertion and engagement pieces 222J and 223J are provided so as to be planted from a circular surface 221Ja of the cap head 221J which circular surface faces a hollow portion of the casing main body 21J, and are provided at positions that are point-symmetric with a center of the circular surface 221Ja as a center of symmetry. In this case, the planted positions of the two insertion and engagement pieces 222J and 223J on the circular surface 221Ja of the cap head 221J are positions included within the hollow portion of the casing main body 21J.

Moreover, in the present example, outer circumferential portions of distal end sides of the insertion and engagement pieces 222J and 223J are provided with protrusions 222Ja and 223Ja. As illustrated in FIG. 21A, the protrusions 222Ja and 223Ja protrude in a direction orthogonal to the axial direction to form step portions, and have tapered portions inclined from the step portions to distal end portions. In the present example, the distal end sides of the two insertion and engagement pieces 222J and 223J are configured to be elastically displaceable in a direction intersecting the axial direction.

On the other hand, as illustrated in FIG. 21A, the casing main body 21J having the cap 22J fitted to a rear end side thereof is provided with through holes 21Ja and 21Jb with which the step portions of the protrusions 222Ja and 223Ja of the insertion and engagement pieces 222J and 223J respectively engage when the cap 22J is fitted to the rear end side of the casing main body 21J.

The cap 22J in the present example is fitted and locked to a rear end of the casing main body 21J as follows. Specifically, the insertion and engagement pieces 222J and 223J of the cap 22J are fitted so as to be pushed into the rear end of the casing main body 21I. Then, the tapered portions of the protrusions 222Ja and 223Ja of the insertion and engagement pieces 222J and 223J of the cap 22J abut against the inner wall surface of the casing main body 21, and the insertion and engagement pieces 222J and 223J of the cap 22J are elastically displaced inward so as to approach each other according to the pushing of the cap 22J into the hollow portion of the casing main body 21J.

Then, as illustrated in FIG. 21A, when the cap head 221J of the cap 22J abuts against a ring-shaped end surface on the rear end side of the casing main body 21J, the step portions of the protrusions 222Ja and 223Ja of the insertion and engagement pieces 222J and 223J of the cap 22J are at positions engageable with the through holes 21Ja and 21Jb of the casing main body 21J.

Therefore, when the positions of the protrusions 222Ja and 223Ja of the insertion and engagement pieces 222J and 223J of the cap 22J are made to coincide with the positions of the through holes 21Ja and 21Jb of the casing main body 21J, the step portions of the protrusions 222Ja and 223Ja of the insertion and engagement pieces 222J and 223J engage with the through holes 21Ja and 21Jb of the casing main body 21J, so that the cap 22J is locked to the rear end side of the casing main body 21J.

The cap 22J thus fitted to the casing main body 21J is removed as follows by using a jig 23J illustrated in FIG. 21B.

As illustrated in FIG. 21B, the jig 23J is formed of an elastic member, for example, resin, and includes rod-shaped protrusions 23Jb and 23Jc formed on one end side and another end side of a semi-arcuate portion 23Ja so as to extend toward an arc center of the semi-arcuate portion 23Ja. In this case, a distance between distal ends of the rod-shaped protrusions 23Jb and 23Jc is a length equal to or slightly smaller than the outside diameter of the casing main body 21J. The thus formed jig 23J can be elastically displaced so as to shorten the distance between the distal ends of the rod-shaped protrusions 23Jb and 23Jc by applying forces as indicated by arrows in FIG. 21B.

In the present example, when the cap 22J is to be separated from the casing main body 21J, the rod-shaped protrusions 23Jb and 23Jc of the jig 23J are inserted into the through holes 21Ja and 21Jb of the casing main body 21J, and are thereafter operated so as to shorten the distance between the distal ends of the rod-shaped protrusions 23Jb and 23Jc by applying forces as illustrated in FIG. 21B to the jig 23J.

Then, the rod-shaped protrusions 23Jb and 23Jc of the jig 23J elastically displace the protrusions 222Ja and 223Ja of the insertion and engagement pieces 222J and 223J of the cap 22J inward, and releases the engagement between the step portions of the protrusions 222Ja and 223Ja of the insertion and engagement pieces 222J and 223J of the cap 22J and the through holes 21Ja and 21Jb of the casing main body 21J. Hence, when the cap head 221J of the cap 22J is pulled in this state, the cap 22J can be separated from the rear end of the casing main body 21J.

It is needless to say that the configuration of the cap is not limited to the configuration described above, but various other configurations are possible as the configuration of the cap.

### OTHER EMBODIMENTS OR MODIFICATIONS

Incidentally, in the foregoing embodiments, the electronic pen main body is assumed to support an active capacitive type electronic pen. However, it is needless to say that the electronic pen main body may be configured to support another type of electronic pen, for example, an electromagnetic induction type electronic pen. That is, this is because the electromagnetic induction type electronic pen also needs to generate digital information by using a control circuit and the control circuit needs to be supplied with a power supply voltage from the power supply in a case where the electronic pen transmits a pen pressure value detected by the pen pressure detector as digital information to the position detecting sensor side and in a case where the electronic pen transmits additional information such as the ID (identification information) of the electronic pen to the position detecting sensor side. In addition, in a case where the electromagnetic induction type electronic pen transmits the additional information and the pen pressure information to the position detecting device side by wireless connection, not only the control circuit but also a wireless communication circuit needs the power supply voltage.

Incidentally, the power supplies in the electronic pens according to the foregoing embodiments use a lithium ion battery cell as a battery cell (battery cell). However, it is needless to say that the battery cell is not limited to this. In addition, while the power supplies in the electronic pens according to the foregoing embodiments have a configuration of a chargeable secondary battery, the power supplies may naturally have a configuration of a primary battery.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. An electronic pen comprising:
a casing configured to separate into a pen tip side and a rear end side, the rear end side on an opposing side from the pen tip side in an axial direction;
an electronic pen main body on the pen tip side in the casing; and
a power supply including a battery and on the rear end side in the casing,
a first terminal on a rear end side in the axial direction of the electronic pen main body, and a second terminal on a pen tip side in the axial direction of the power supply,
in the casing, the first terminal of the electronic pen main body and the second terminal of the power supply being in contact with and electrically coupled to each other, and the electronic pen main body and the power supply being in the axial direction, without being physically coupled to each other, by inserting and fitting an end in the axial direction of one of the electronic pen main body and the power supply into an end in the axial direction of the other, and
the power supply being extractable to an outside of the casing by separating the casing into the pen tip side and the rear end side.

2. The electronic pen according to claim 1, wherein
the electronic pen main body includes a core body having a distal end projecting outward from an opening on the pen tip side of the casing, a pen pressure detector configured to detect a pressure applied to the distal end of the core body, a transmitter configured to transmit a signal to be sent out to the outside from the pen tip side, and a circuit board on which at least a part of the transmitter is disposed, and the electronic pen main body is supplied with a power supply voltage from the power supply through the first terminal and the second terminal.

3. The electronic pen according to claim 1, wherein
the power supply includes a plurality of battery cells, and a positive electrode terminal and a negative electrode terminal of an output voltage are formed in the second terminal.

4. The electronic pen according to claim 1, wherein
the separable distal end side of the casing is a tubular pen case, and the rear end side of the casing is a cap configured to be fitted to a rear end side of the pen case,
the first terminal of the electronic pen main body and the second terminal of the power supply are brought into elastic pressure contact with and electrically coupled to each other by fitting the cap member to the rear end side of the pen case, and
the power supply is extracted from the rear end side of the pen case by separating the cap member from the rear end side of the pen case.

5. The electronic pen according to claim 4, wherein
the cap has an elastic member configured to elastically displace the power supply to a side of the electronic pen main body.

6. The electronic pen according to claim 4, wherein
the cap includes a tubular portion configured to be inserted into the rear end side of the pen case, and the tubular portion is provided with an elastic displacement mechanism for locking the cap to the pen case by pressing an inner wall surface of the pen case in a state in which the cap is fitted to the pen case, and
the cap is provided with a through hole into which a member for releasing the pressing of the inner wall surface of the pen case by the elastic displacement mechanism is inserted.

7. The electronic pen according to claim 1, wherein
the electronic pen main body has the first terminal on a first end surface on the rear end side in the axial direction,
the power supply has the second terminal on a second end surface on the pen tip side in the axial direction, and
the electronic pen main body and the power supply are provided so as to be arranged in the axial direction in a state in which the first end surface provided with the first terminal and the second end surface provided with the second terminal are opposed to and in contact with each other in the casing.

8. The electronic pen according to claim 7, wherein
at least one of the first terminal on the first end surface and the second terminal on the second end surface is configured to include a pogo pin (contact probe) that is elastically displaceable in the axial direction in a columnar housing space in the casing.

9. The electronic pen according to claim 1, wherein
the separable distal end side and the rear end side of the casing are coupled to each other by screwing, and separation releases the screwing, and
the first terminal of the electronic pen main body and the second terminal of the power supply are in elastic pressure contact with and electrically coupled to each other in a coupled state in which the distal end side and the rear end side of the casing are screwed to each other.

10. The electronic pen according to claim 1, wherein
the battery in the power supply is a secondary battery, and
the electronic pen main body is provided with a charging circuit for charging the secondary battery and an external power supply connector for coupling the charging circuit to an external power supply for charging.

11. The electronic pen according to claim 10, wherein
the external power supply connector is constituted by a universal serial bus connector (USB).

12. The electronic pen according to claim 11, wherein,
for the universal serial bus connector, an opening of a terminal portion for the external power supply is provided on a side circumferential surface of the casing, and
a power supply connector coupled to the external power supply is configured to be inserted into the universal serial bus connector from a direction orthogonal to the axial direction of the casing through the opening.

13. The electronic pen according to claim 12, wherein
the electronic pen main body includes a core body having a distal end projecting outward from an opening on the pen tip side of the casing, a pen pressure detector configured to detect a pressure applied to the distal end of the core body, a transmitter configured to transmit a signal to be sent out to the outside from the pen tip side, and a circuit board on which at least a part of the transmitter is disposed, and
the universal serial bus connector is disposed in a notch of the circuit board in the electronic pen main body.

14. The electronic pen according to claim 10, wherein
the external power supply connector is configured to be coupled to the external power supply on a noncontact basis.

15. The electronic pen according to claim 14, wherein
the external power supply connector includes a coil for electromagnetic induction.

16. The electronic pen according to claim 1, wherein
a recess is formed in a circumferential direction of an outer circumferential side surface of the casing at an axial direction position of the casing, the axial direction position being in a vicinity of a position at which the rear end side of the electronic pen main body and the pen tip side of the power supply abut against each other, and
the casing is separated into the pen tip side and the rear end side by being ruptured at the recess.

17. The electronic pen according to claim 1, wherein
the power supply is configured to be exposed to the outside so as to be extractable in a direction orthogonal to the axial direction of the casing when the casing is separated into the pen tip side and the rear end side.

18. The electronic pen according to claim 17, wherein
the electronic pen main body and the power supply are disposed in a boat-shaped holder in casing, and the power supply is configured to be extractable in the direction orthogonal to the axial direction of the casing with respect to the holder, and,
when the casing is separated into the pen tip side and the rear end side, the boat-shaped holder in which the electronic pen main body and the power supply are disposed is made movable without being fixed in the casing, and the power supply is exposed to the outside so as to be extractable in the direction orthogonal to the axial direction of the casing.

19. The electronic pen according to claim 10, wherein
the secondary battery uses a lithium ion battery cell.

20. The electronic pen according to claim 1, wherein
the electronic pen main body has an active capacitive configuration.

21. The electronic pen according to claim 1, wherein
the electronic pen main body has an electromagnetic induction configuration.
